(19) United States
(12) Patent Application Publication
(10) Pub. No.: US 2018/0121074 A1
(43) Pub. Date: May 3, 2018

(54) FREEHAND TABLE MANIPULATION

(71) Applicant: Microsoft Technology Licensing, LLC, Redmond, WA (US)

(72) Inventors: Gilles Louis Peron, Redmond, WA (US); Ron Mondri, Bellevue, WA (US); Ian William Mikutel, Redmond, WA (US); Laurentiu Pavel, Bellevue, WA (US)

(73) Assignee: Microsoft Technology Licensing, LLC, Redmond, WA (US)

(21) Appl. No.: 15/445,348

(22) Filed: Feb. 28, 2017

Related U.S. Application Data
(60) Provisional application No. 62/414,646, filed on Oct. 28, 2016.

(51) Int. Cl. G06F 3/0488; G06F 17/24; G06F 3/0484

(52) U.S. Cl. CPC G06F 3/04883; G06F 3/0484; G06F 17/245

(57) ABSTRACT

Recognition of freehand input enables gestures and objects to be recognized as tables and actions taken in relation to tables. For example, drawing a rectangle intersected by horizontal and vertical lines will create a table object that functions as a table within a productivity application, but may inherit visual cues from the strokes used to draw it. Users are enabled to move, add to, remove from, reorganize, delete, and perform value-based calculations on and in the table via freeform input.

### CROSS-REFERENCES TO RELATED APPLICATIONS

The present disclosure claims priority to U.S. Provisional Patent Application No. 62/414,646 filed Oct. 28, 2016, the disclosure of which is hereby incorporated by reference in its entirety.

### BACKGROUND

Users create content in productivity applications with a variety of input tools with various benefits and tradeoffs associated with those tools. In one example, a user may format text to appear in a tabular format in various cells of a table (divided into rows and columns). Some users author tabular content in purpose-made applications (e.g., spreadsheets) to work with tabular content or insert special table objects into other applications to handle tabular content. Other users manually adjust the spacing of content items, via page sizes/margins, line breaks, tabs, spaces, etc., to present content in a tabular format. Still other users create and space objects containing content (e.g., text boxes, shape stencils) to form a tabular presentation. All of these approaches, however, require the user to select specific tools in the productivity application, which may be buried in layers of a contextual menu, or rely on formatting rulers (or an “eyeball” estimate) to maintain a uniform table structure, which degrades the user's authoring experience and lengthens the time it takes to create a table to the user's specification.

### SUMMARY

This summary is provided to introduce a selection of concepts in a simplified form that are further described below in the Detailed Description section. This summary is not intended to identify all features of the claimed subject matter, nor is it intended as limiting the scope of the claimed subject matter.

Systems and methods are provided herein to enable improved usability of productivity applications that enables the intelligent detection and manipulation of tables via freehand input. As a user makes freehand input in the productivity application, it is determined whether the freehand input corresponds to an object, such as a table, and the freehand input is applied in association with the object to modify that object, without requiring the user to access a menu to adjust the object. For example, after using freehand input to draw a table, a table object (including cells organized in rows and columns) is created in the productivity application based on the freehand input. The user may refine that table (or another table input via freehand conversion or via an insertion) with additional freehand input, such as, for example, by drawing a new cell, row, or column; splitting or merging existing cells; or deleting existing cells, rows, or columns.

By employing the present disclosure, an improved user experience is provided, where the user is enabled to input and refine table objects via freehand input—without having to switch authoring tools or access menus—faster, more accurately, and more efficiently than before.

The details of one or more aspects are set forth in the accompanying drawings and description below. Other features and advantages will be apparent from a reading of the following detailed description and a review of the associated drawings. It is to be understood that the following detailed description is explanatory only and is not restrictive; the proper scope of the present disclosure is set by the claims.

### BRIEF DESCRIPTION OF THE DRAWINGS

The accompanying drawings, which are incorporated in and constitute a part of this disclosure, illustrate various aspects of the present disclosure. In the drawings:

FIG. 1 illustrates a block diagram of a system enabled to accept document content inputs and to enable incremental revealing or hiding of content on a canvas in an electronic authoring environment;

FIGS. 2A and 2B illustrate the detection of a table from freehand input;

FIGS. 3A and 3B illustrate the manipulation of a table via freehand input to draw an additional column;

FIGS. 4A and 4B illustrate the manipulation of a table via freehand input to add an additional column via a gesture;

FIGS. 5A and 5B illustrate splitting a cell of a table via freehand input;

FIGS. 6A and 6B illustrate merging two cells of a table via freehand input;

FIGS. 7A and 7B illustrate reorganizing the rows of a table via freehand input;

FIGS. 8A and 8B illustrate performing a calculation on a table via freehand input;

FIGS. 9A and 9B illustrate manipulating a table via freehand input to impart formatting from the freehand input to the table;

FIGS. 10A, 10B, and 10C illustrate manipulating a table via freehand input to insert values into cells of the table;

FIG. 11 is a flowchart showing general stages involved in an example method for providing intelligent detection of a table from freehand input;

FIG. 12 is a flowchart showing general stages involved in an example method for providing intelligent manipulation of a table and its contents via freehand input;

FIG. 13 is a block diagram illustrating physical components of a computing device with which examples may be practiced;

FIGS. 14A and 14B are block diagrams of a mobile computing device with which aspects may be practiced; and

FIG. 15 is a block diagram of a distributed computing system in which aspects may be practiced.

### DETAILED DESCRIPTION

The following detailed description refers to the accompanying drawings. Wherever possible, the same reference numbers are used in the drawings and the following description to refer to the same or similar elements. While aspects of the present disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the present disclosure, but instead, the proper scope of the present disclosure is defined by the appended claims. Examples may take the form of a hardware implementation, or an entirely software implementation, or an implementation combining software and hardware aspects. The following detailed description is, therefore, not to be taken in a limiting sense.

Systems and methods are provided herein to enable improved usability of productivity applications that enables the intelligent detection and manipulation of tables via freehand input. As a user makes freehand input in the productivity application, it is determined whether the freehand input corresponds to an object, such as a table, and the freehand input is applied in association with the object to modify that object, without requiring the user to access a menu to adjust the object. For example, after using freehand input to draw a table, a table object (including cells organized in rows and columns) is created in the productivity application based on the freehand input. The user may refine that table (or another table input via freehand conversion or via an insertion) with additional freehand input, such as, for example, by drawing a new cell, row, or column; splitting or merging existing cells; or deleting existing cells, rows, or columns. Recognition of freehand input enables gestures, strokes, and objects to be recognized as tables and actions taken in relation to tables. For example, drawing a rectangle intersected by horizontal and vertical lines will create a table object that functions as a table within a productivity application, but may inherit visual cues from the strokes used to draw it. Users are enabled to move, add to, remove from, reorganize, delete, and perform value-based calculations on and in the table via freeform input.

By employing the present disclosure, an improved user experience is provided, where the user is enabled to input and refine table objects via freehand input—without having to switch authoring tools or access menus—faster, more accurately, and more efficiently than before. Additionally, because the user is not required to switch authoring tools, less memory and fewer processing resources are expended to author content in the productivity application, and the functionality of the computing device used to provide the productivity application is thereby expanded and improved.

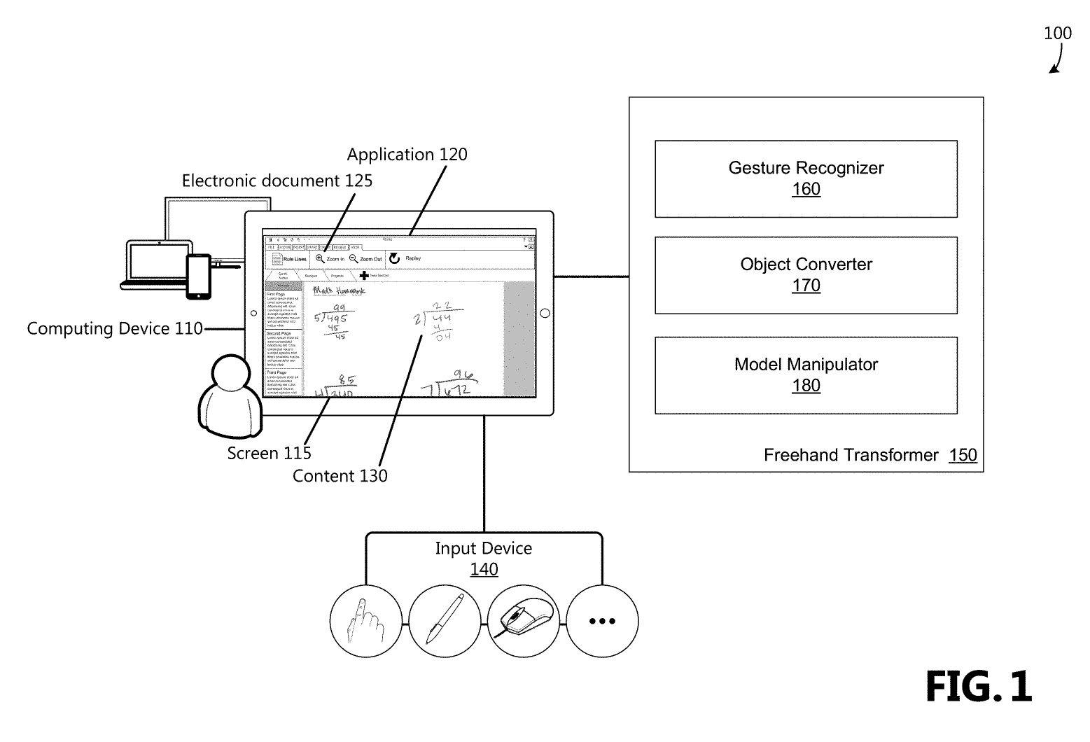

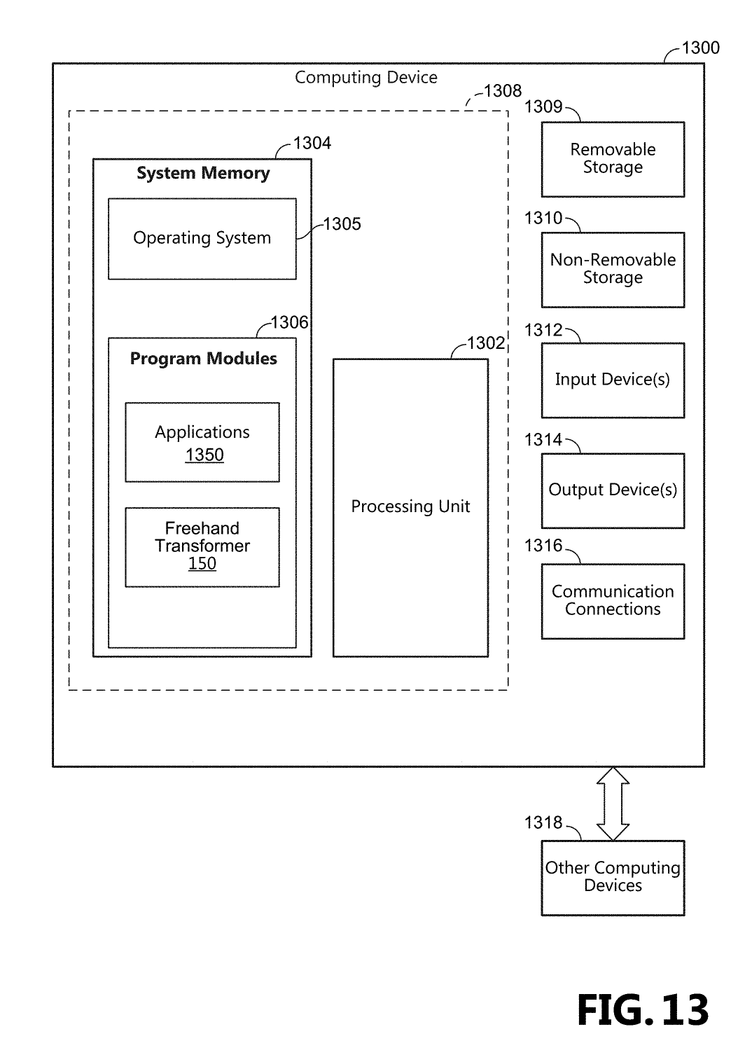

With reference now to FIG. 1, a block diagram of one example environment 100 in communication with freehand transformer 150 is shown. As illustrated, the example environment includes a computing device 110. The computing device 110 is one of various types of device, including, but not limited to: a tablet computing device, a desktop computer, a mobile communication device, a laptop computer, a laptop/tablet hybrid computing device, a large screen multi-touch display, a gaming device, a smart television, a wearable device, or other type of computing apparatus for executing applications 120 for performing a variety of tasks. The hardware of these computing apparatuses is discussed in greater detail in regard to FIGS. 13, 14A, 14B, and 15.

A user may interact with an application 120 on the computing device 110 for performing a variety of tasks, which include, but are not limited to: writing, calculating, drawing, taking and organizing notes, preparing and organizing presentations, sending and receiving electronic mail, making music, and the like. Applications 120 include thick client applications, which may be stored locally on the computing device 110, and thin client applications (i.e., web applications) that reside on a remote server and are accessible over a network, such as the Internet or an intranet. In various aspects, a thin client application is hosted in a browser-controlled environment or coded in a browser-supported language and is reliant on a web browser to render the application 120 executable on the computing device 110. According to an aspect, the application 120 is a program that is launched and manipulated by an operating system, and manages content 130 within an electronic document 125 and is published on a display screen 115 associated with the computing device 110.

The content 130 in an electronic document 125 will vary according the application 120 used to provide the electronic document 125. The content 130 may comprise one or more objects present or imbedded in the electronic document 125 including, but not limited to: text (including text containers), numeric data, macros, images, movies, sound files, and metadata. According to one example, the content 130 includes a plurality of digital strokes, sometimes referred to herein as “inking” input, wherein a stroke is a data object that is collected from a pointing device, such as a tablet pen, a finger, or a mouse via freehand input. In various aspects, a stroke is created and manipulated programmatically, and is represented visually on an ink-enabled element, such as an ink canvas of an application 120. In some examples, a stroke contains information about both its position and appearance. In other aspects, freehand input includes using a line tool used to form a shape or object from constituent lines or individual stencils to form a more complex shape (e.g., a triangle stencil and a rectangle stencil to form an arrow shape, multiple rectangle stencils to form a grid).

In various aspects, the data comprising the content 130 are stored in an elemental form by the electronic document 125, such as in Extensible Markup Language (XML) or Java Script Object Notation (JSON) elements or another declaratory language interpretable by a schema. The schema may define sections or content items via tags and may apply various properties to content items via direct assignment or hierarchical inheritance. For example, an object comprising text may have its typeface defined in its element definition (e.g., “<text typeface=garamond>example text</text>”) or the typeface may be defined by a stylesheet or an element above the object in the document's hierarchy from which the element depends.

With reference still to FIG. 1, an application 120 includes or is in communication with a freehand transformer 150, operative to provide extended operations in the application 120 via freehand input. In one example, the computing device 110 includes a freehand transformation application programming interface (API), operative to enable the application 120 to employ the systems and methods of the present disclosure via stored instructions.

According to aspects, the freehand transformer 150 includes: a gesture recognizer 160; an object converter 170; and a model manipulator 180. The components of the freehand transformer 150 are illustrative of software modules, systems, or devices operative to receive freehand input and manipulate objects within the content 130 of an electronic document 125 based on the freehand input. According to aspects, the freehand input includes a physical act or motion performed on or by an input device 140 (e.g., finger, pen/stylus, mouse) at a position of a user-controlled cursor (such as a mouse cursor or touch-point on a touch-screen interface) that is interpreted by the application 120 as a stroke or other gesture to apply to the content 130 of an electronic document 125. The freehand input includes “inking” input to add strokes for the electronic document 125 as well as gestures that are interpretable based on their shape, speed, pressure, number of inputs (e.g., one finger, two fingers, etc.), and relative position to existing content 130. According to an example, the input device 140 is a pointing device used to specify a position (e.g., x, y coordinates) on a graphical user interface (GUI), and manipulate on-screen objects.

According to one aspect, the gesture recognizer 160 is operable to receive freehand input indicative of an object being selected, for example, via a tap, double-tap, lasso tool, finger drag, selection-inherent gesture, or hover. In one example, the gesture recognizer 160 identifies the position of the user-controlled cursor (e.g., mouse cursor or touch-point) and the relative positions of objects and portions thereof (e.g., a row, a column, a cell, a border) to determine how the freehand input is to be applied within the electronic document 125.

According to an aspect, the object converter 170 is illustrative of a software module, system, or device operable to convert various freehand inputs into strokes that are part of the table object or are to be used as property input for the table object. For example, when a user is interacting with a shape object of a rectangle or box in the electronic document 125 and provides strokes that are interpreted by the gesture recognizer 160 as comprising vertical and/or horizontal strokes on top of the shape object, the object converter 170 converts those strokes and the shape object into a table object at the position of the shape object in the canvas of the electronic document 125. The initial shape object and the strokes are removed from the electronic document 125 and converted into a table object. In another example, the object converter 170 converts gestures interpreted as providing data for the cells of a table object (e.g., hand-written letters or numerals) into alphanumeric values interpretable by the Document Object Model (DOM). In yet another example, when the user draws additional strokes proximate to or coincident with the table object (preexisting or freehand-created), the object converter 170 is operable to adjust the number, size, ordering, positioning, and properties of the rows and/or columns of the table in response to the additional strokes.

The model manipulator 180 is illustrative of a software module, system, or device operative to update the DOM of the electronic document 125 based on the freehand input applied to an object in the content 130. In a first example, when the freehand input indicates that a table object is to be created, the model manipulator 180 is operable to remove the strokes for the bounding shape and the row/column defining strokes and replace them with a table object in the DOM. In a second example, when the freehand input indicates that an additional stroke is added to or manipulates the table object, the model manipulator 180 is operable to adjust the table object in the DOM accordingly (adding, removing, rearranging cells, rows, or columns, etc.). In a third example, when the freehand input is interpreted as including handwritten alphanumeric characters coincident with a cell of the table, the model manipulator 180 is operable to adjust the stored value for that cell in the DOM to include the formula or value represented by the handwritten characters.

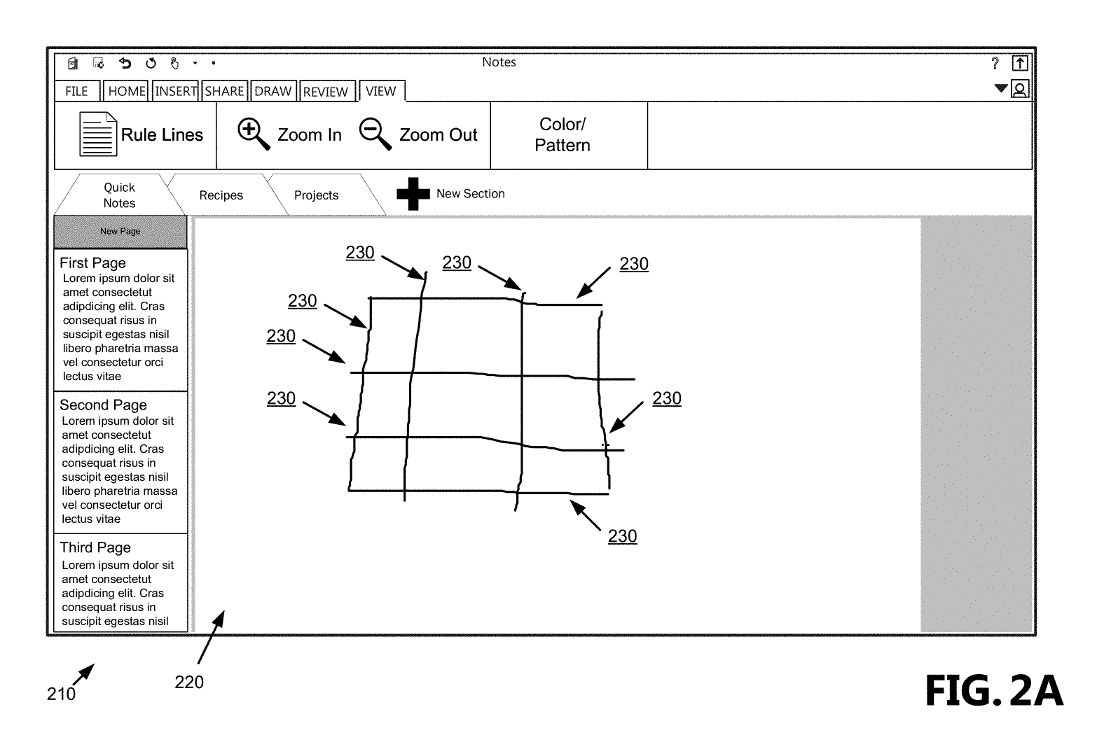

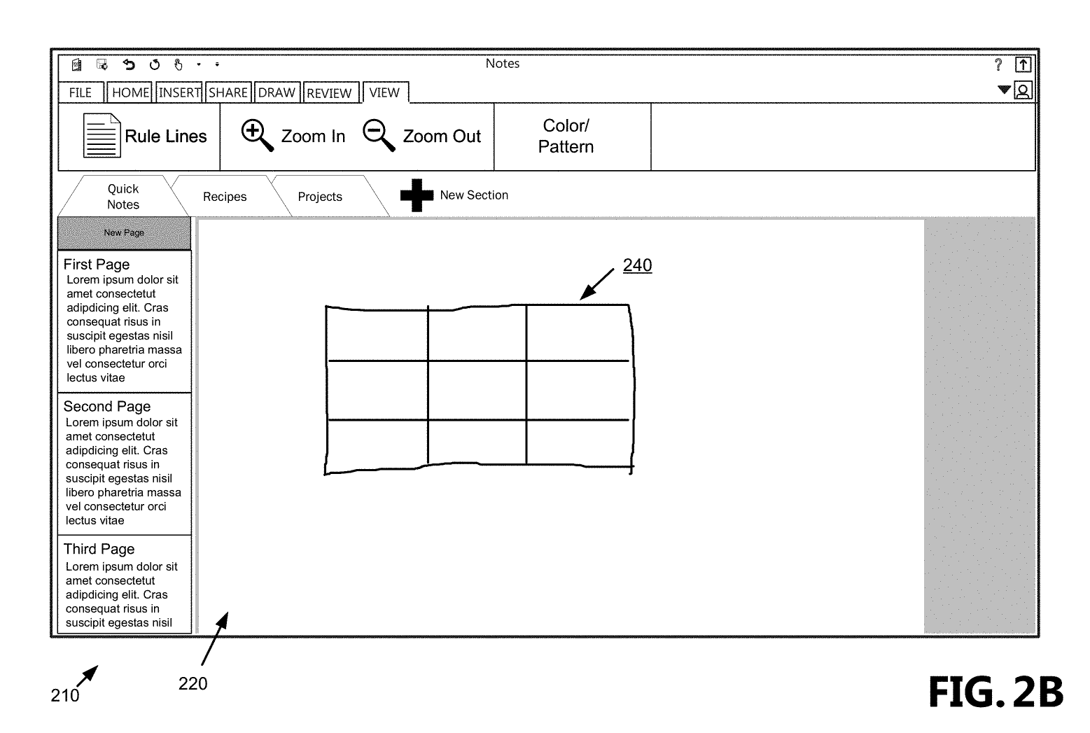

Several various example scenarios of the determination and manipulation of an enriched table object (preexisting or freehand-created) via freehand input are provided in relation to FIGS. 2A-10C. FIGS. 2A-10C show various example GUIs 210 for a note taking application including a canvas 220 in which content 130 is authored via freehand input that illustrate various features and aspects of freehand input determination and manipulation of tables and their contents. The canvas 220 accepts freehand input via an input device 140 to produce one or more stroke inputs 230 that are recognized by the freehand transformer 150 to produce object and gestures in the electronic document 125. These stroke inputs 230 are interpreted as various objects that are incorporated into the DOM of the electronic document 125, including, but not limited to, incorporated table objects 240 (including one or more incorporated cells 245, organized in rows and columns) and handwritten characters that are interpretable to select candidate values for inclusion as the values of the incorporated cells 245 (which may be adjusted via candidate controls 260 to select different candidate values based on the handwritten characters). As will be appreciated, the examples illustrated in FIGS. 2A-10C are non-limiting illustrations; other GUIs from other application types with different elements and arrangements thereof may be used in conjunction with the present disclosure. For example, various controls may be presented, in addition to or instead of recognizing objects and gestures that are actuable via freehand input to perform various operations of the table.

FIGS. 2A and 2B illustrate the detection of a table from freehand input. As the user makes stroke inputs 230 to the canvas 220 in FIG. 2A, the freehand transformer 150 determines that the stroke inputs 230 define a table object. In various aspects, the table object includes stroke inputs 230 as well as other objects (e.g., a previously inserted box or rectangle object) that define internal and/or external borders of the table and its cells. The freehand transformer 150, is operable to employ various thresholds for the number of cells defined by the borders, a relative angle of the candidate borders (between one another or a ruler of the electronic document 125), relative spacing of the candidate borders, and size of the stroke inputs 230 to aid in determining whether a table object is being defined or another object (e.g., a character, a drawing, a coloring/hatching effect) is being defined.

When it is determined that the stroke inputs 230 of the freehand input define a table that meets the threshold criteria of the freehand transformer 150, the objects and strokes defining the table are removed from the DOM and replaced with an incorporated table object 240, including one or more incorporated cells 245, that inherit their display properties from the prior objects and strokes, as is shown in FIG. 2B. In various aspects, the incorporated table object 240 inherits the shape, color, size, position, and/or line effects of the stokes and objects defining the table, the shape, color, size, position, and/or line effects of the strokes and objects defining an outer border of the incorporated table object 240, or inherits based on the size and position of the initial strokes and objects. In various aspects, some or all of the strokes are “smoothed” from their freehand input state to provide straighter, more evenly spaced, and/or more evenly angled borders than were used to define the table, but that are not perfectly straight, spaced, or angled, to thereby impart a look-and-feel associated with handwriting or drawing rather than computer-generation.

According to one aspect, an incorporated cell 245 may also inherit a content item that was previously internal to an object used to define the incorporated table 240. For example, a box containing (defining an area around) a character or another object that defines an outer border of the table object may pass that character or object as a value for the incorporated cell 245 that defines the area around that character or object. For example, a box with the number “5” (five) in the upper right corner—handwritten or otherwise—may pass that number to an upper right cell of a table defined by that box to contain as a content item for that cell once the incorporated table object 240 is created.

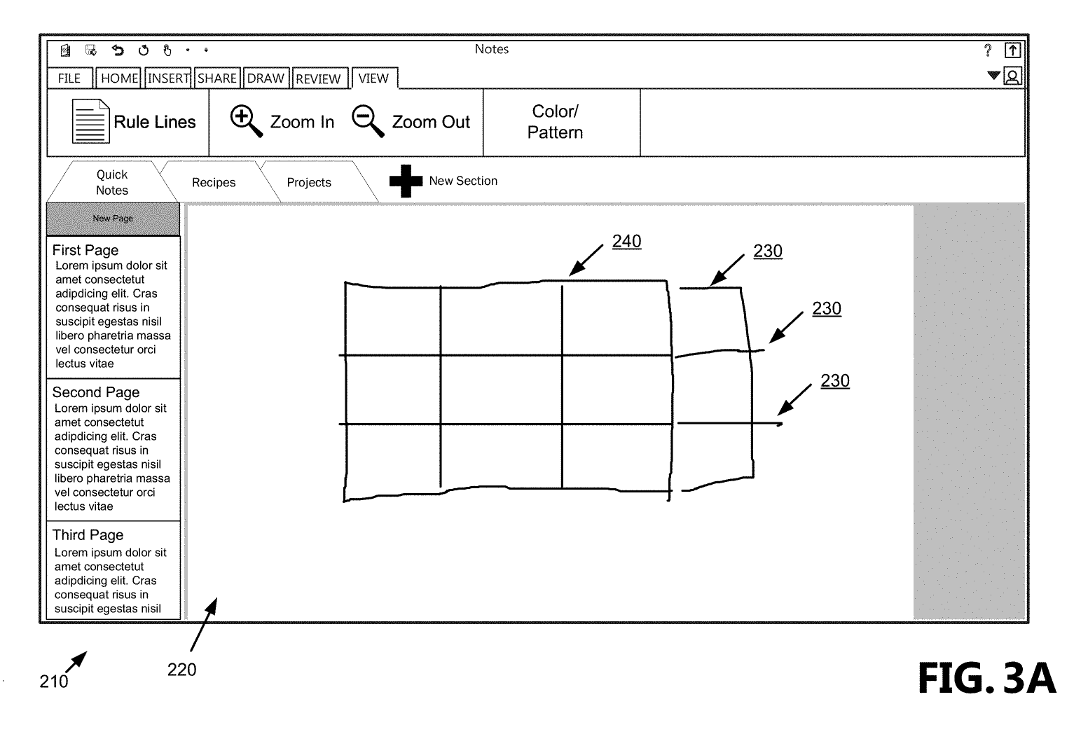

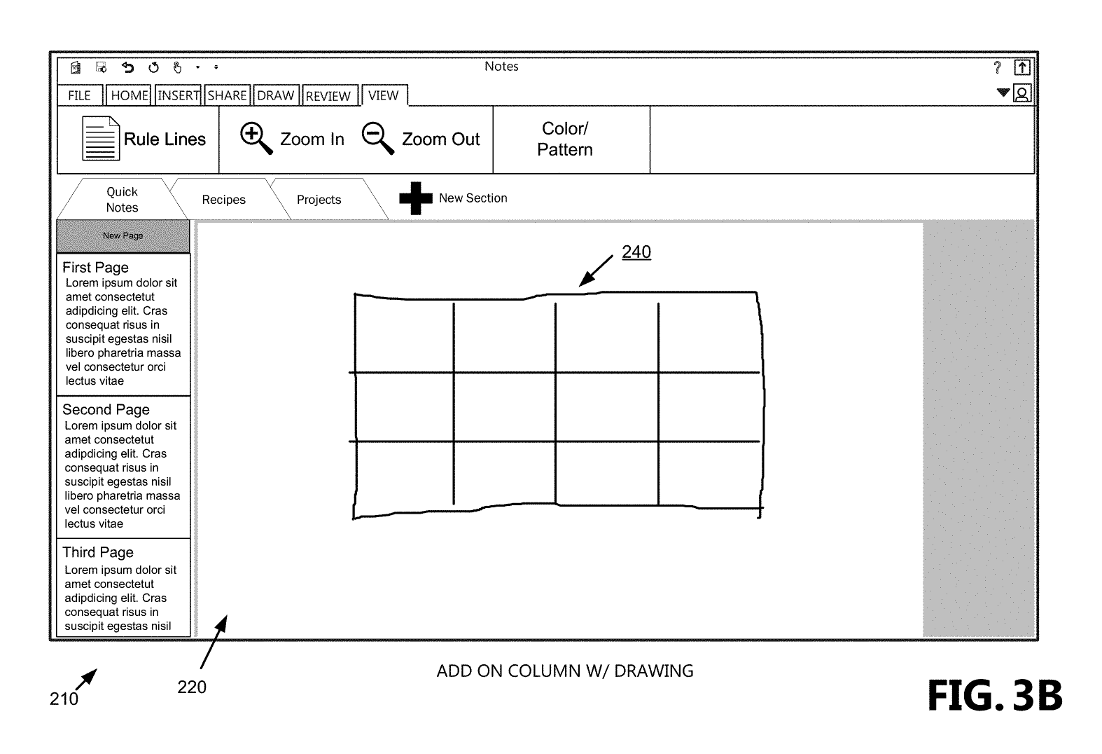

FIGS. 3A and 3B illustrate the manipulation of a table via freehand input to draw an additional column. In the example GUI 210 shown in FIG. 3A, the canvas 220 already includes an incorporated table object 240, and the user has input additional stroke inputs 230. The freehand transformer 150 identifies the stroke inputs 230, based on their size, orientation, and position relative to the incorporated table object 240, as user interaction to manipulate the incorporated table object 240. As illustrated in FIG. 3B, the interpreted manipulation is recognized as an interaction with the incorporated table object 240 to add a new column, which expands the incorporated table object 240 to include the new column. As is illustrated, the stroke inputs 230 are removed from the canvas 220 as they are incorporated into the incorporated table object 240. Additional manipulations include drawing a vertical or horizontal line across a whole column or row to insert a new column or row after the element, similar to splitting a given cell, but for a whole column or row.

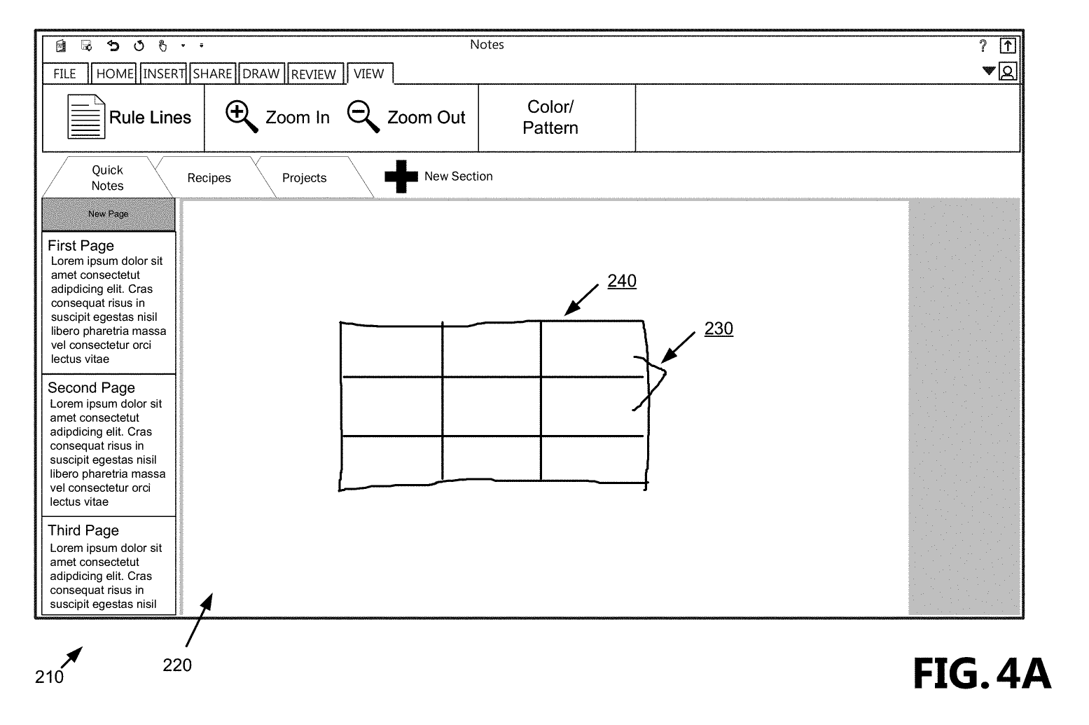

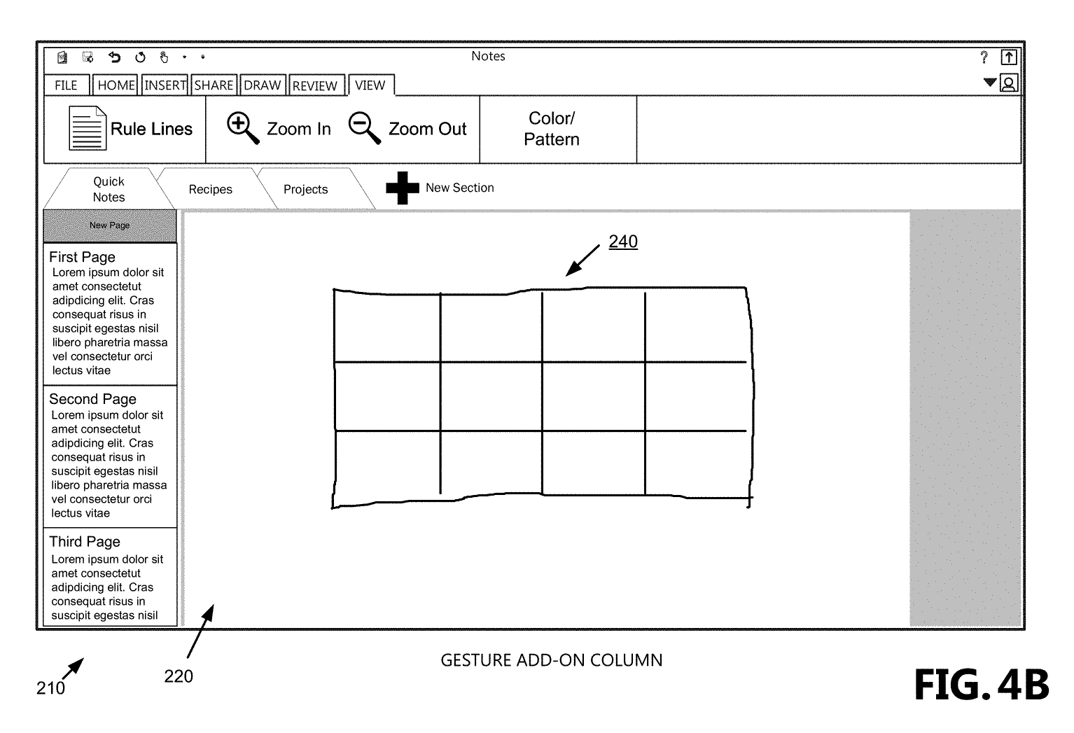

FIGS. 4A and 4B illustrate the manipulation of a table via freehand input to add an additional column via a gesture. In the example GUI 210 shown in FIG. 4A, the canvas 220 already includes an incorporated table object 240, and the user has input additional stroke input 230 of a chevron (or other gesture) relative to a border of a column. The freehand transformer 150 identifies the stroke input 230, based on its size, orientation, and position relative to the incorporated table object 240, as user interaction to manipulate the incorporated table object 240. As illustrated in FIG. 4B, the interpreted manipulation is recognized as an interaction with the incorporated table object 240 to add a new column, which expands the incorporated table object 240 to include the new column. As is illustrated, the stroke inputs 230 are removed from the canvas 220 as the gesture they represent is incorporated into the incorporated table object 240.

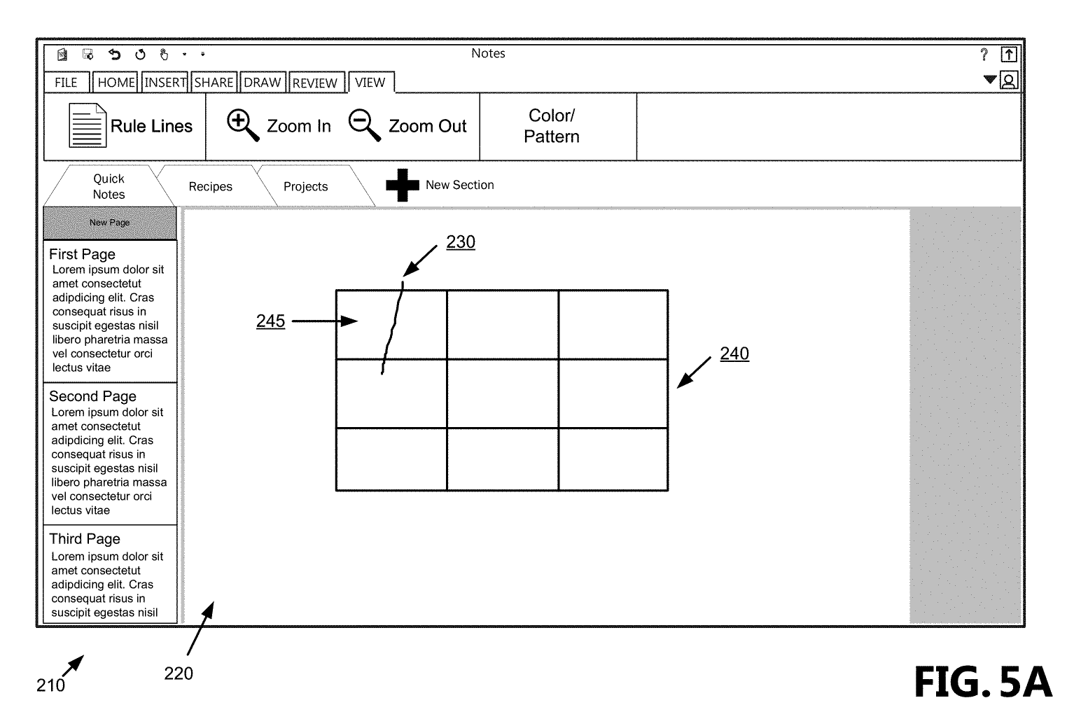

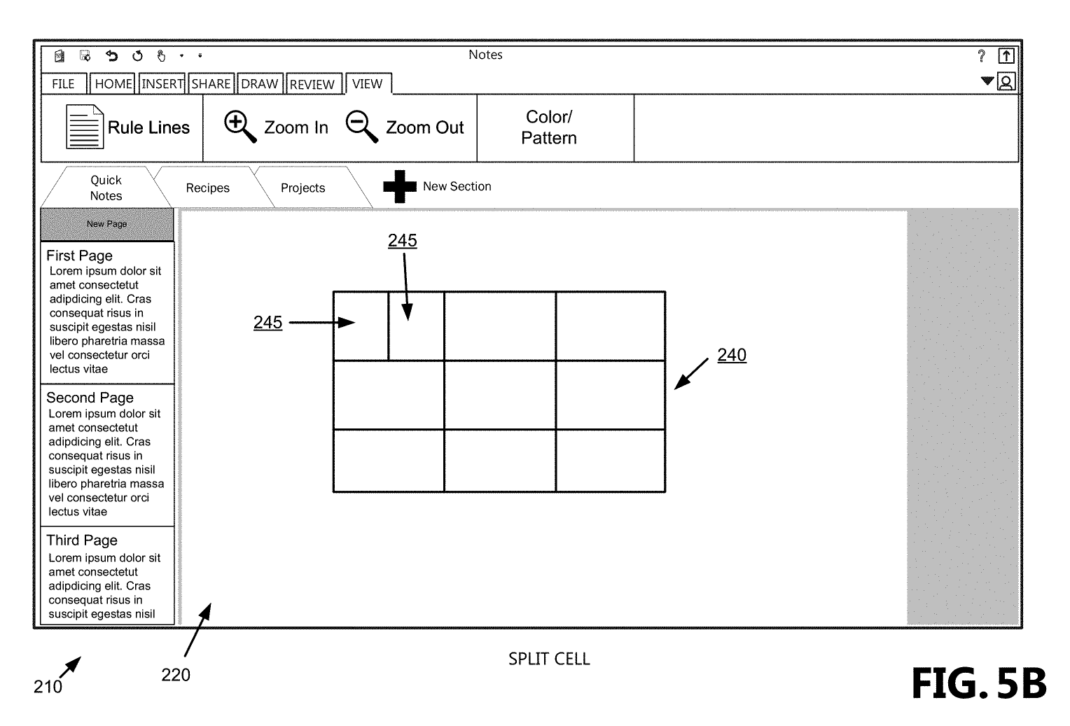

FIGS. 5A and 5B illustrate splitting a cell of a table via freehand input. In the example GUI 210 shown in FIG. 5A, the canvas 220 already includes an incorporated table object 240, and the user has input an additional stroke input 230 of a slash bisecting an incorporated cell 245. The freehand transformer 150 identifies the stroke input 230 based on its size, orientation, and position relative to the incorporated table object 240 as user interaction to manipulate the incorporated table object 240. As illustrated in FIG. 5B, the interpreted manipulation is recognized as an interaction with the incorporated table object 240 to split the given incorporated cell 245 into multiple cells, which breaks the incorporated cell 245 into two distinct cells at the current position in the incorporated table object 240. As is illustrated, the stroke input 230 is removed from the canvas 220 as the gesture it represents is incorporated into the incorporated table object 240.

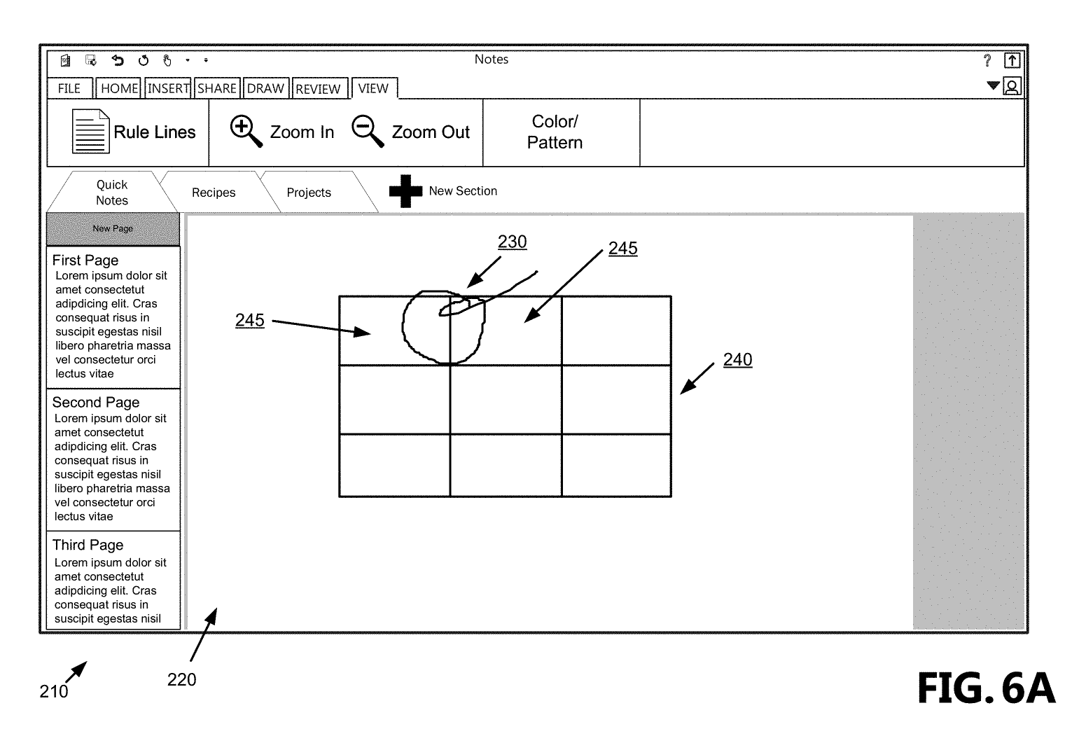

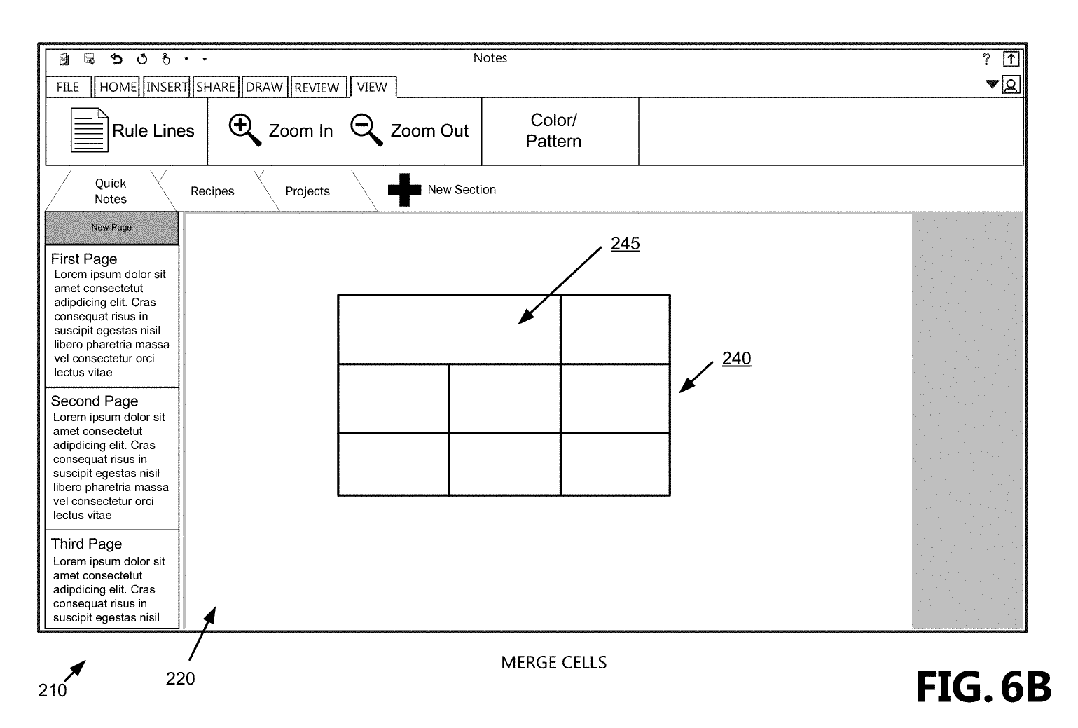

FIGS. 6A and 6B illustrate merging two cells of a table via freehand input. In the example GUI 210 shown in FIG. 6A, the canvas 220 already includes an incorporated table object 240, and the user has input an additional stroke input 230 of a selection and removal gesture of a border between two incorporated cells 245. The freehand transformer 150 identifies the stroke input 230 based on its size, orientation, and position relative to the incorporated table object 240 as user interaction to manipulate the incorporated table object 240. As illustrated in FIG. 6B, the interpreted manipulation is recognized as an interaction with the incorporated table object 240 to merge the given incorporated cells 245 into a single cell, which removes the border between the incorporated cells 245 and leaves a single cell at the current position in the incorporated table object 240. As is illustrated, the stroke input 230 is removed from the canvas 220 as the gesture it represents is incorporated into the incorporated table object 240.

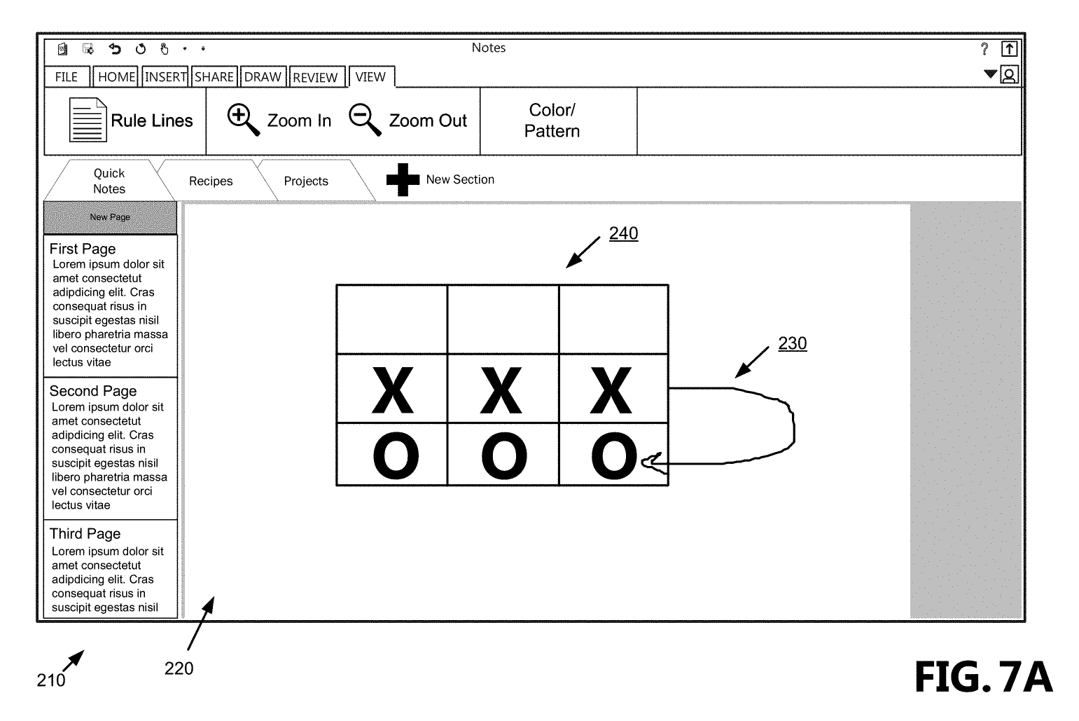

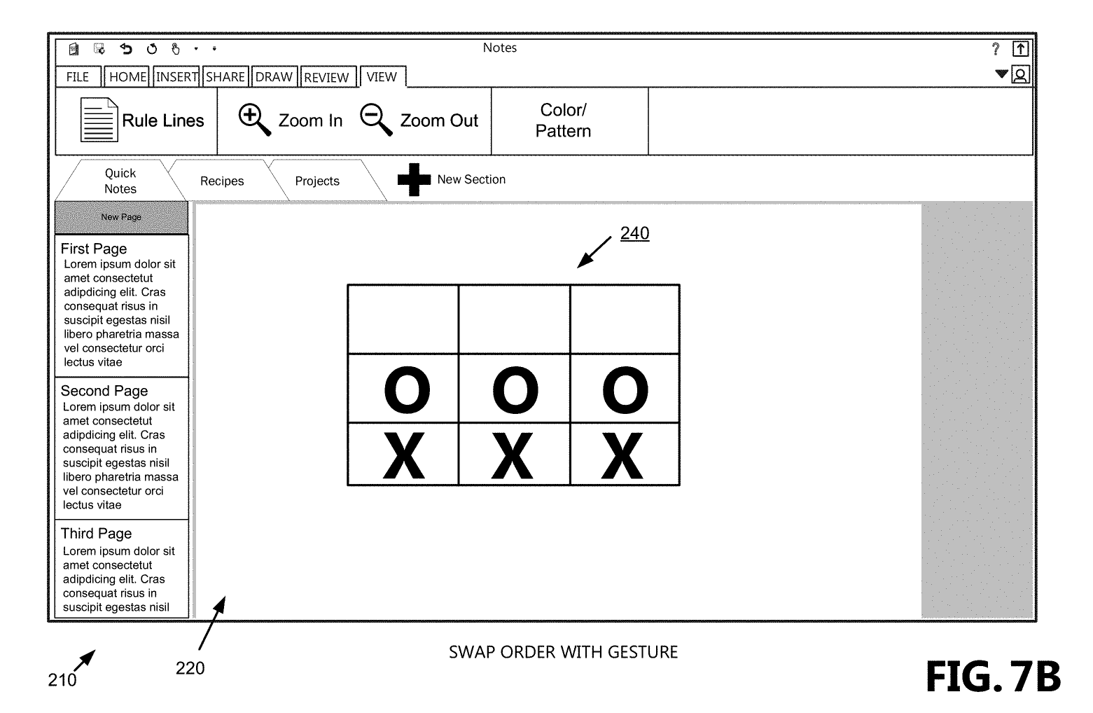

FIGS. 7A and 7B illustrate reorganizing the rows of a table via freehand input. In the example GUI 210 shown in FIG. 7A, the canvas 220 already includes an incorporated table object 240, with a central row of incorporated cells 245 with values of “X” and a bottom row of incorporated cells 245 with values of “O”. The user has input an additional stroke input 230 of an arrow leading from the central row to the bottom row. The freehand transformer 150 identifies the stroke input 230 based on its size, orientation, and position relative to the incorporated table object 240 as user interaction to manipulate the incorporated table object 240. As illustrated in FIG. 7B, the interpreted manipulation is recognized as an interaction with the incorporated table object 240 to reorganize the rows of the incorporated table object 240, which has moved the row of incorporated cells 245 with values of “X” to the bottom row and the row of incorporated cells 245 with values of “O” to the central row. As is illustrated, the stroke input 230 is removed from the canvas 220 as the gesture it represents affects the incorporated table object 240.

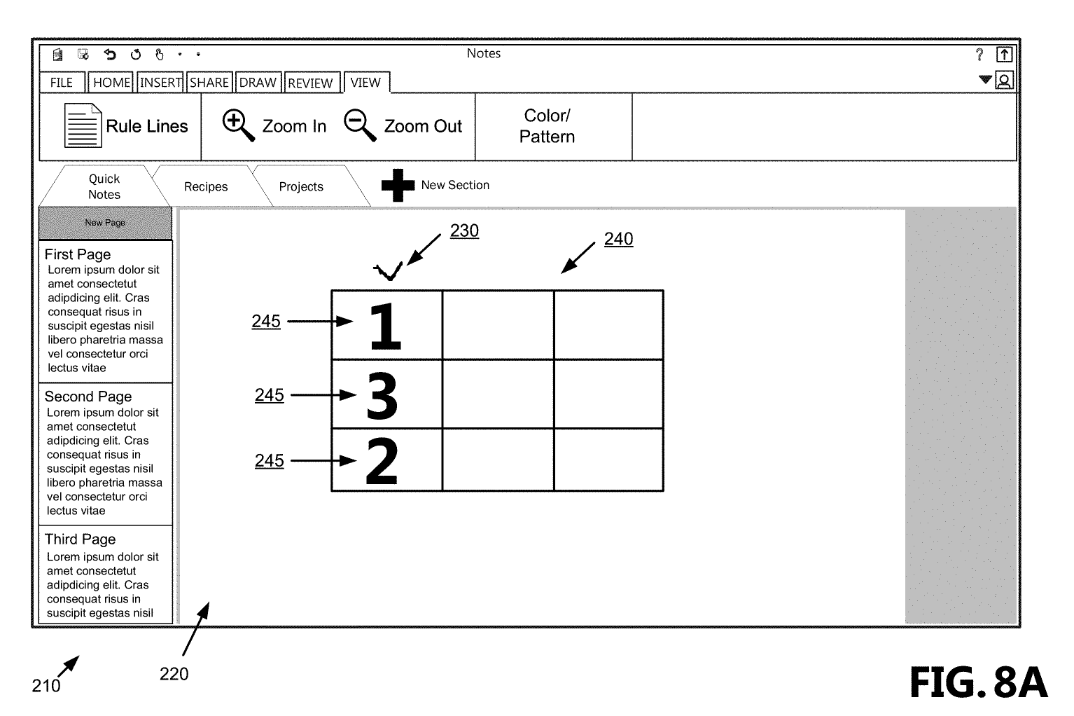

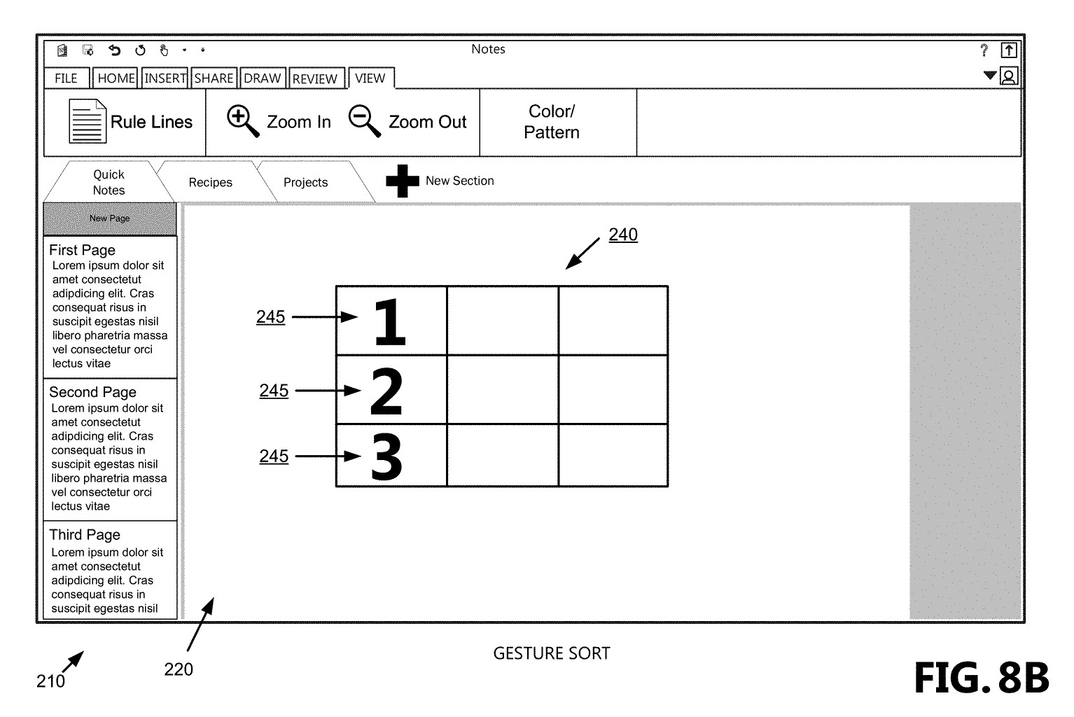

FIGS. 8A and 8B illustrate performing a calculation manipulation on a table via freehand input based on the values contained in its cells. In the example GUI 210 shown in FIG. 8A, the canvas 220 already includes an incorporated table object 240, with a column of incorporated cells 245 with values of “1” (one), “3” (three), “2” (two) from top to a bottom. The user has input an additional stroke input 230 above the column of a chevron pointing downward. In other aspects, a chevron pointing in a different direction (e.g., upward) may have a different or opposite effect. The freehand transformer 150 identifies the stroke input 230 based on its size, orientation, and position relative to the incorporated table object 240 as user interaction to manipulate the incorporated table object 240. As illustrated in FIG. 8B, the interpreted manipulation is recognized as an interaction with the incorporated table object 240 to sort the incorporated cells 245 of the row based on their values, from least to greatest, which has sorted incorporated cells 245 to “1” (one), “2” (two), “3” (three) from top to a bottom. As is illustrated, the stroke input 230 is removed from the canvas 220 as the gesture it represents affects the incorporated table object 240.

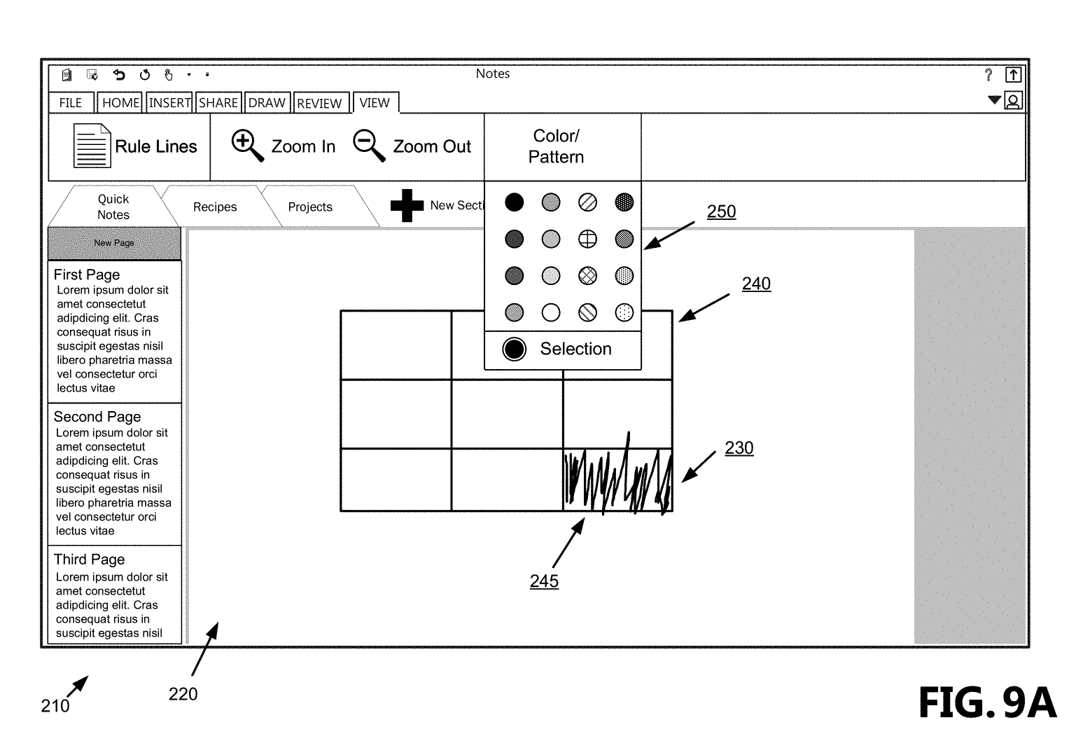

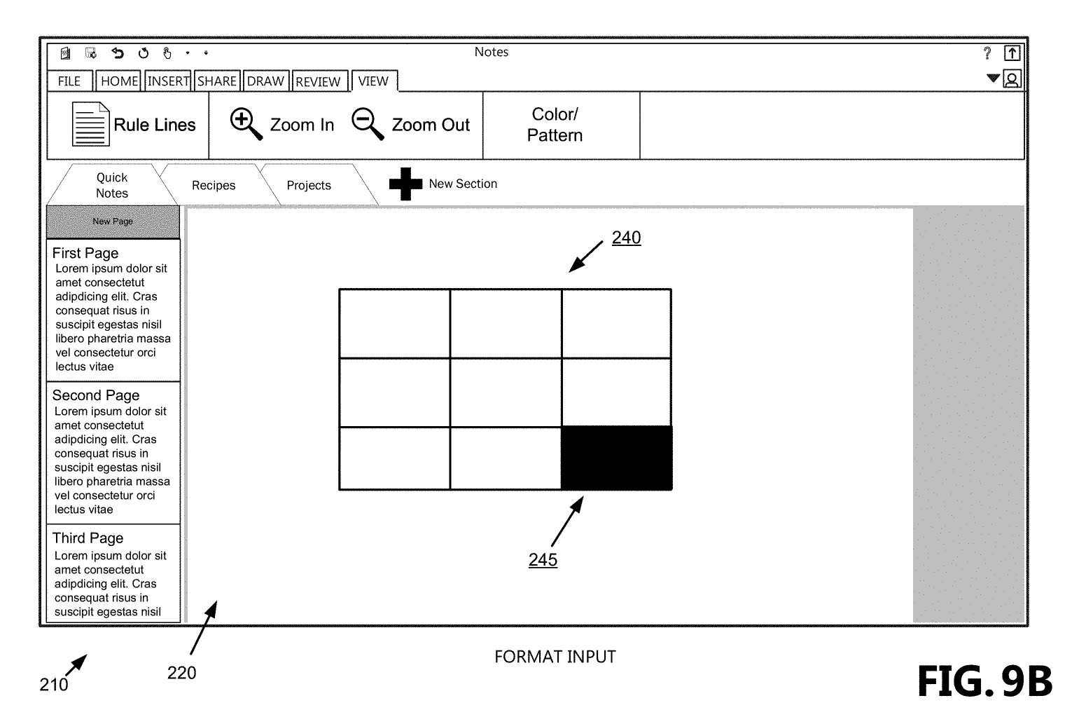

FIGS. 9A and 9B illustrate manipulating a table via freehand input to impart formatting from the freehand input to the table. In the example GUI 210 shown in FIG. 9A, the canvas 220 already includes an incorporated table object 240, and the user has input an additional stroke input 230 of a scribble having selected an effect (a color and/or a pattern) from a GUI element 250 within an incorporated cell 245. The freehand transformer 150 identifies the stroke input 230 based on its size, orientation, and position relative to the incorporated table object 240 as user interaction to manipulate the incorporated table object 240. As illustrated in FIG. 9B, the interpreted manipulation is recognized as an interaction with the incorporated table object 240 to apply formatting information (e.g., a color) from the stroke input 230 to the incorporated cell 245. As is illustrated, the stroke input 230 is removed from the canvas 220 as the gesture it represents affects the incorporated table object 240. In another example, a user may apply the format for a stroke input 230 to a border of a cell or the table by tracing the border. In a further example, a user may apply a highlighter tool over cells to accept the highlighter's color as a background color.

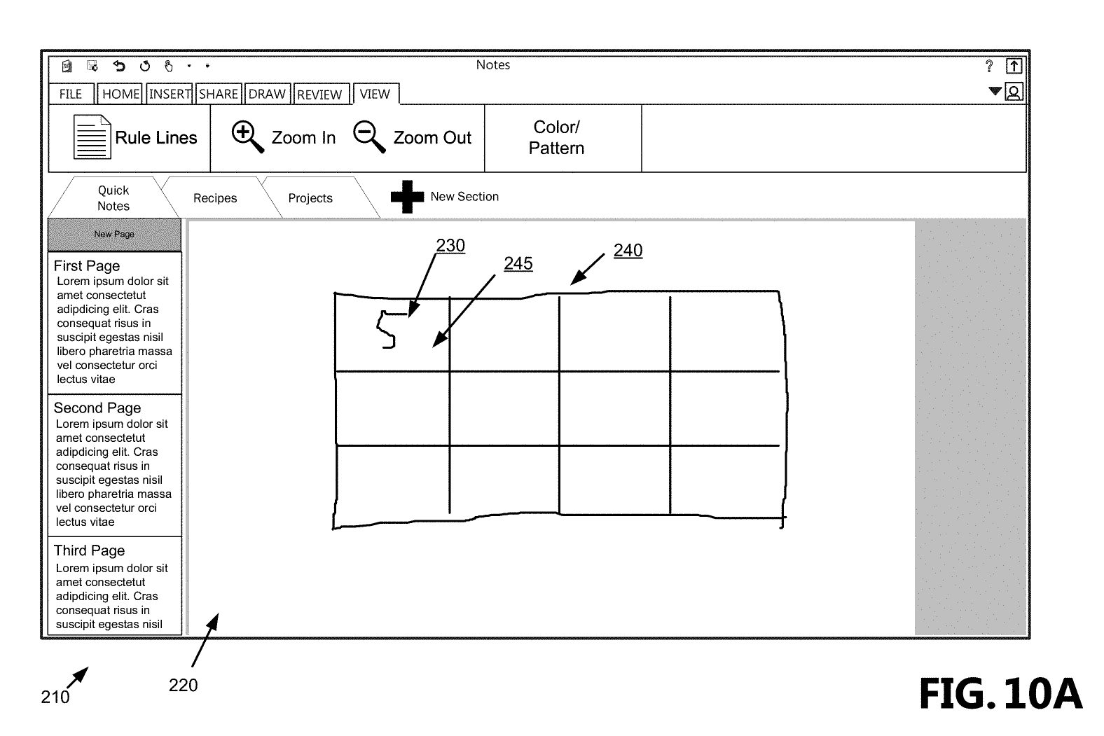

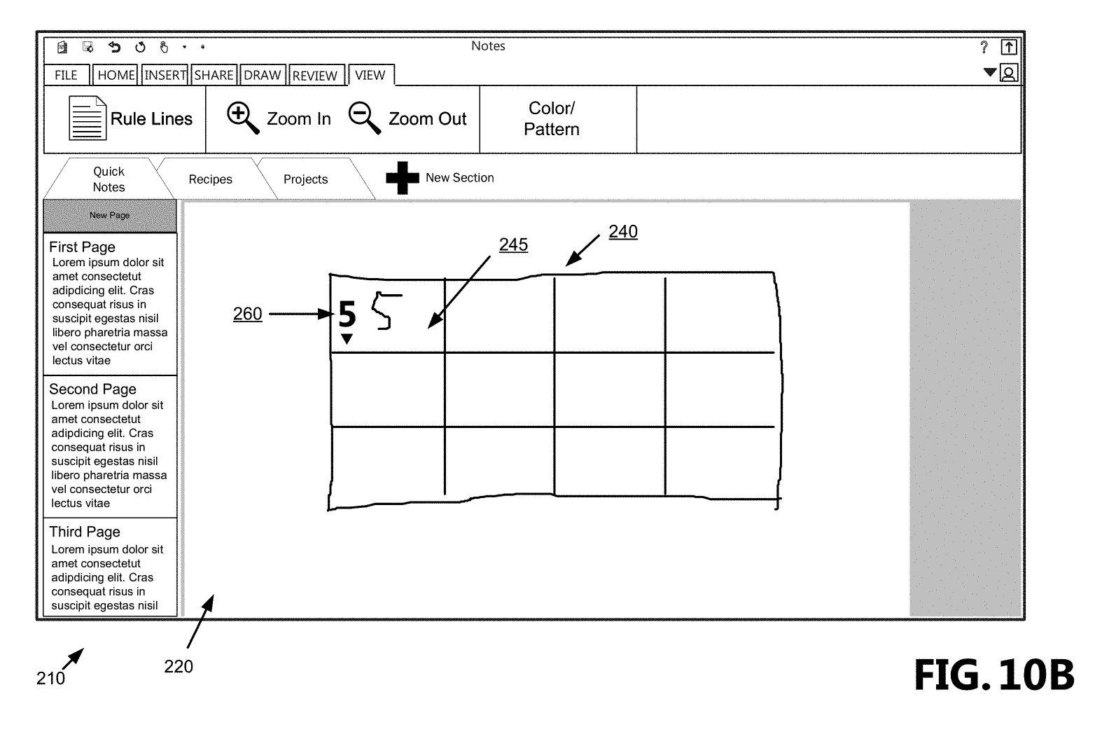

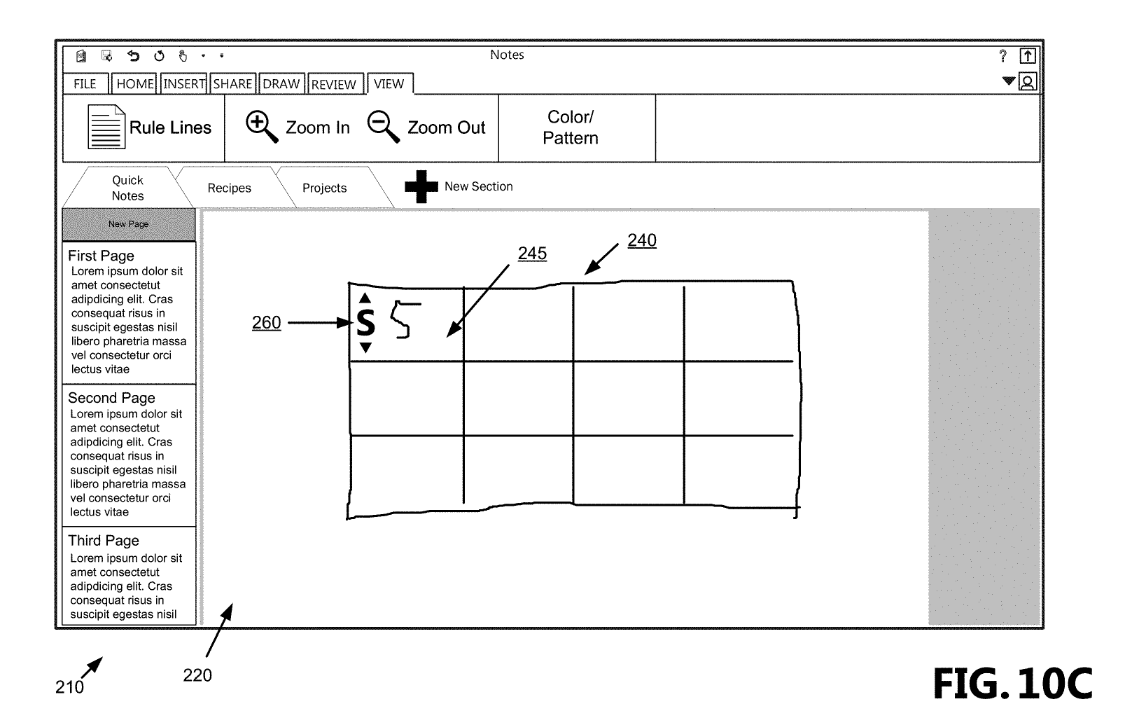

FIGS. 10A, 10B, and 10C illustrate manipulating a table via freehand input to insert values into cells of the table. In the example GUI 210 shown in FIG. 10A, the canvas 220 already includes an incorporated table object 240, and the user has input an additional stroke input 230 of a character above or coincident to an incorporated cell 245. The freehand transformer 150 identifies the stroke inputs 230, based on their size, orientation, and position relative to the incorporated table object 240, as user interaction to manipulate the incorporated table object 240 intended to add content to the cell. In various aspects, the freehand transformer 150 uses various Optical Character Recognitions (OCR) and handwriting analysis algorithms in associated with various libraries of characters to determine the character or characters that the stroke input 230 represents.

As illustrated in FIG. 10B, the freehand transformer 150 has determined that the strokes inputs 230 represent the character “5” (five) from among the candidate characters that were examined and displays its selection of the character via a computer-generated typeface in association with a candidate control 260. The stroke inputs 230 are incorporated as content into the incorporated cell 245, and the candidate value is incorporated into the DOM of the incorporated table object 240 to allow calculations and value-based manipulations to use the candidate value, but for the incorporated cell 245 to display the freehand input representation of that value. In various aspects, the candidate value is displayed, but not printed or is displayed only when an associated cell is selected to preserve the hand drawn look-and-feel of the table.

The candidate controls 260 enable a user to select (via freehand input or otherwise) to change the displayed candidate value to a second candidate value. As is illustrated in FIG. 10C, the user has progressed from FIG. 10B to select the uppercase Latin letter “S” instead of the previously selected value of “5” (five). The candidate controls 260 enable the user to cycle through multiple candidate values to identify the “best” candidate value; the value that matches the user's interpretation of the freeform input. In various aspects, an order of the candidates (including the initial “best” candidate selected by the freehand transformer 150) is influenced by the content of other cells, the other characters identified within the cell, the libraries of characters available to the user, and the user's prior handwriting.

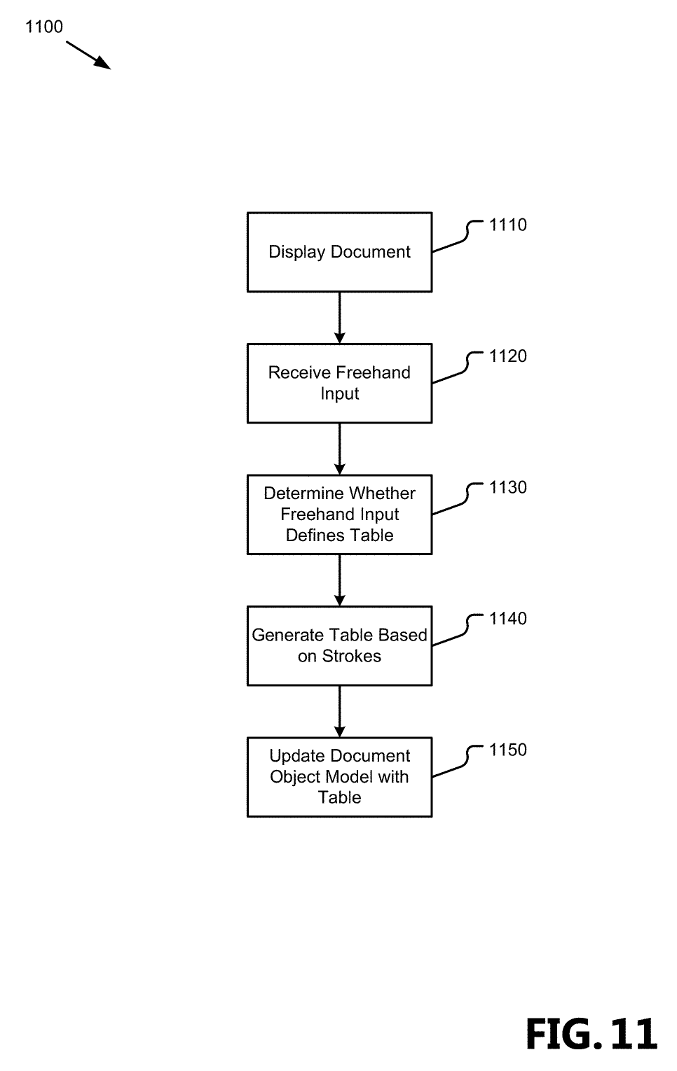

FIG. 11 is a flowchart showing general stages involved in an example method 1100 for providing intelligent detection of a table from freehand input. Method 1100 begins at OPERATION 1110 as an electronic document 125 with a canvas capable of receiving freehand input for the entry of content 130 is displayed. At OPERATION 1120 freehand input, including one or more strokes, is received in the canvas. Freehand input may be received by one or more various types of input devices 140 and may be made to empty spaces in the canvas or one top of or overlapping existing content 130.

At OPERATION 1130 it is determined whether the freehand input defines a table. Freehand input that defines a table includes strokes that define a table border and cell borders (defining rows and columns via handwritten strokes), strokes that define cell borders on an existing content object that defines a table border, and strokes that define a table border around an existing content object that defines cell borders. In various aspects, the relative angles, spacing, size, and number of strokes defining a bound grid are analyzed to determine whether the freehand input are to be interpreted as defining a table or are to be interpreted as defining another object (e.g., a character or drawing). For example, the Chinese character of “ [symbol] ” (field) may be differentiated from a table object based on the size of the strokes falling below a size threshold to define a table object or a number of strokes (defining cells) falling below a number threshold to define a table. Similarly, thresholds for evenness of spacing of strokes or relative angles of strokes (i.e., whether the strokes are considered substantially parallel) are operable to differentiate other objects from table objects.

When it is determined that the freehand input defines a table, the table object is generated based on the strokes at OPERATION 1140. The table object, in various aspects, retains some or all of the strokes of the freehand input to define the outer and inner border of the table object. In other aspects, straight (or partially straightened) lines replace some or all of the freehand strokes, to give the table object a more computer-generated look-and-feel than the freehand strokes. The table object occupies the same space in the canvas as the strokes did and may optionally include the visual appearance of the strokes (e.g., line colors, thicknesses, dash patterns, ink effects), but at OPERATION 1150, the individual strokes (or other objects) used to define the table are replaced in the DOM of the electronic document 125 with a table object. The table object defines various cells, which are operable to hold various values (including formulas and references to other cells and data sources) and are organized into rows and columns.

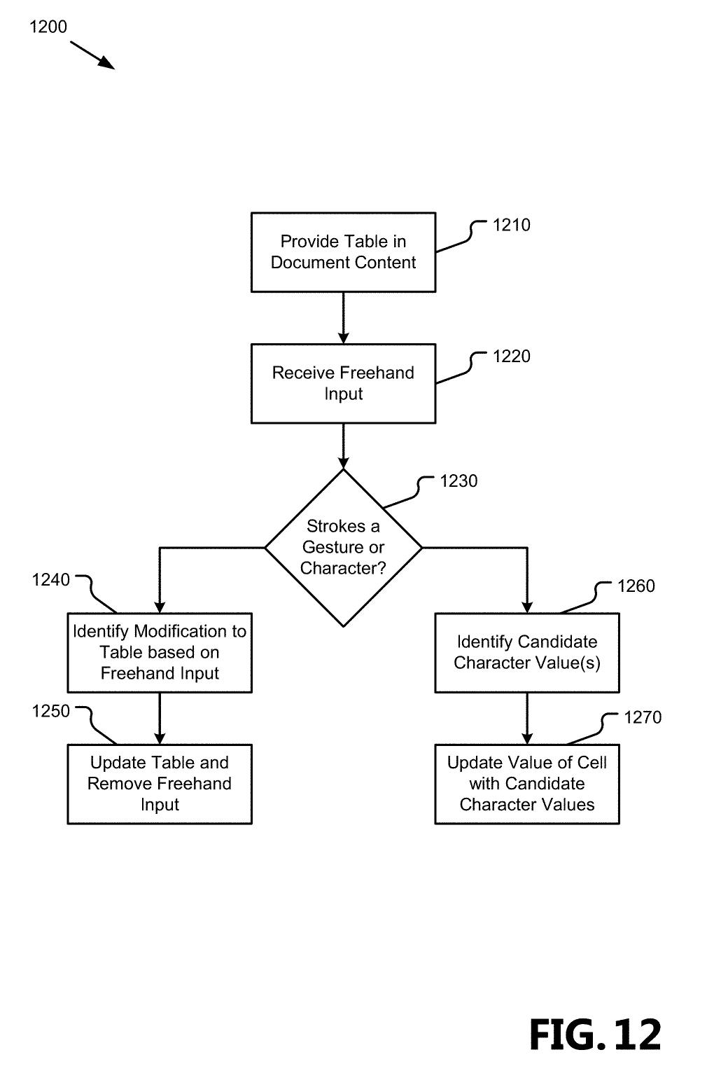

FIG. 12 is a flowchart showing general stages involved in an example method 1200 for providing intelligent manipulation of a table and its contents via freehand input. The table manipulated in method 1200 includes freehand-created tables, including those generated according to method 1100, as well as preexisting tables, including spreadsheet ranges and table objects inserted in an authoring canvas by a table generation tool or menu. Method 1200 begins at OPERATION 1210 with a table being provided in the canvas of an electronic document 125 that is operable to receive freehand input. The table provided in the canvas is enriched by the freehand transformer 150 to accept freehand input to interpret as commands to modify the table, without the need for a user to access a menu, user interface affordance, dialog, or the like; the user is enabled to draw or write in the canvas via Natural User Input to affect the enriched table.

The freehand input to affect the enriched table is received at OPERATION 1220 and it is interpreted at DECISION 1230 to determine how the strokes that make up the freehand input are to be interpreted to affect the table. As will be appreciated, the shape and number of strokes of the freehand input, the input device 140 used to provide the strokes, and a location of the strokes relative to the table or portions of the table will affect the determination of how to interpret freehand input, and different aspects may interpret the same freehand input differently. For example, a first freehand transformer 150 receiving freehand input of a vertical line over a cell of the table via multi-touch input determines that the numeral “1” (one) is to be input as a value into that cell, whereas a second freehand transformer 150 receiving the same freehand input would determine that the cell is to be split into two cells.

When it is determined at DECISION 1230 that the freehand input indicates a gesture to modify the table, method 1200 proceeds to OPERATION 1240, where the modification and its effect on the table are identified. Example modifications to a table that may be indicated by freehand input include, but are not limited to: adding a cell, row, or column at a given position; removing a cell, row, or column at a given position; splitting a given cell; merging two or more cells; applying a visual effect to a cell, row, column, or the table (e.g., inner, outer, inner and outer borders); moving a cell, row, column, or the table; inserting content (e.g., via a clipboard gesture or linking to another range or document) from another document or application; and resizing a cell, row, column, or the table.

Once the freehand input's associated modification to the table is identified, method 1200 proceeds to OPERATION 1250, where the table is updated according to the identified modification and the strokes of the freehand input are removed from the canvas of the electronic document 125.

When it is determined at DECISION 1230 that the freehand input indicates that data are to be included as values in one or more cells of the table, method 1200 proceeds to OPERATION 1260, where the strokes of the freehand input are analyzed to determine candidate characters that the strokes represent. In various aspects it is determined that the freehand input is to be interpreted as value input to affect the value of the table's cells (not gesture input) based on the position of the freehand input relative to the cells of the table (e.g., coincident or “over” a given cell) and the shape of the strokes of the freehand input being recognized as one or more characters via a character recognition tool (e.g., OCR, handwriting analysis tools). In various aspects, the candidate characters include letters, numbers, and special characters (e.g., mathematical symbols, punctuation marks), but depending on user options may also include or exclude characters from various alphabets (e.g., Latin, Greek, Cyrillic), syllabaries (e.g.,

Katakana, Hiragana), or other character sets (e.g., traditional Chinese, simplified Chinese).

The freehand transformer 150 is operable to analyze the strokes to determine a “best” candidate character of the identified candidate characters to incorporate as a value for the cell. For example, when a user inputs a vertical stroke, the freehand transformer may recognize multiple candidate characters, such as, for example, the characters “1” (one), “I” (uppercase Latin I), “l” (lowercase Latin L), “|” (vertical slash), “ [symbol] ” (Katakana syllable No), etc., based on the included character sets from which to recognize characters, from which one character value is selected as a most likely (the “best”) value to match the user's freehand input. In various aspects, a computer-generated character associated with the “best” candidate character value is displayed to the user along with controls to enable the user select a different candidate character. For example, if it is initially determined by the freehand transformer 150 that the vertical stroke is to be interpreted as the character for “1” (one), the user may manually (via freehand input or otherwise) identify a different candidate character (e.g., “l”—lowercase Latin L) as the best match to the strokes. In various aspects, the freehand transformer 150 is operable to adjust which characters are initially selected as the “best” characters based on other characters in a given cell or the table (e.g., a circular stroke is interpreted as “0” (zero) when another numeral is present but as “O” (uppercase Latin O) when another alphabetic character is present) or prior user behaviors/handwriting styles. Depending on the size of the characters determined to belong to a cell of the table object, individual cells (or rows or columns) may be resized as the inputs are made to the cells. Individual characters may be treated as a word for manipulation as a single object.

The value of the identified best candidate character (or characters comprising a word, multi-digit number, or formula) is incorporated as the value of the cell at OPERATION 1270. In various aspects, the computer generated characters are displayed in the cell along with the freehand stokes, the computer generated characters replace the freehand strokes for display in the cell, or the freehand strokes remain displayed in the cell without computer generated characters being displayed (lending a handwritten appearance to the table, but allowing numeric calculations to be made in the DOM).

While implementations have been described in the general context of program modules that execute in conjunction with an application program that runs on an operating system on a computer, those skilled in the art will recognize that aspects may also be implemented in combination with other program modules. Generally, program modules include routines, programs, components, data structures, and other types of structures that perform particular tasks or implement particular abstract data types.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, according to an aspect, the aspects and functionalities described herein operate over distributed systems (e.g., cloud-based computing systems), where application functionality, memory, data storage and retrieval and various processing functions are operated remotely from each other over a distributed computing network, such as the Internet or an intranet. According to an aspect, user interfaces and information of various types are displayed via on-board computing device displays or via remote display units associated with one or more computing devices. For example, user interfaces and information of various types are displayed and interacted with on a wall surface onto which user interfaces and information of various types are projected. Interaction with the multitude of computing systems with which implementations are practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

FIGS. 13-15 and the associated descriptions provide a discussion of a variety of operating environments in which examples are practiced. However, the devices and systems illustrated and discussed with respect to FIGS. 13-15 are for purposes of example and illustration and are not limiting of a vast number of computing device configurations that are used for practicing aspects, described herein.

FIG. 13 is a block diagram illustrating physical components (i.e., hardware) of a computing device 1300 with which examples of the present disclosure may be practiced. In a basic configuration, the computing device 1300 includes at least one processing unit 1302 and a system memory 1304. According to an aspect, depending on the configuration and type of computing device, the system memory 1304 comprises, but is not limited to, volatile storage (e.g., random access memory), non-volatile storage (e.g., read-only memory), flash memory, or any combination of such memories. According to an aspect, the system memory 1304 includes an operating system 1305 and one or more program modules 1306 suitable for running software applications 1350. According to an aspect, the system memory 1304 includes a freehand transformer 150, operable to enable a software application 1350 to employ the teachings of the present disclosure via stored instructions. The operating system 1305, for example, is suitable for controlling the operation of the computing device 1300. Furthermore, aspects are practiced in conjunction with a graphics library, other operating systems, or any other application program, and is not limited to any particular application or system. This basic configuration is illustrated in FIG. 13 by those components within a dashed line 1308. According to an aspect, the computing device 1300 has additional features or functionality. For example, according to an aspect, the computing device 1300 includes additional data storage devices (removable and/or non-removable) such as, for example, magnetic disks, optical disks, or tape. Such additional storage is illustrated in FIG. 13 by a removable storage device 1309 and a non-removable storage device 1310.

As stated above, according to an aspect, a number of program modules and data files are stored in the system memory 1304. While executing on the processing unit 1302, the program modules 1306 (e.g., freehand transformer 150) perform processes including, but not limited to, one or more of the stages of the methods 1100 and 1200 illustrated in FIGS. 11 and 12. According to an aspect, other program modules are used in accordance with examples and include applications such as electronic mail and contacts applications, word processing applications, spreadsheet applications, database applications, slide presentation applications, drawing or computer-aided application programs, etc.

According to an aspect, the computing device 1300 has one or more input device(s) 1312 such as a keyboard, a mouse, a pen, a sound input device, a touch input device, etc. The output device(s) 1314 such as a display, speakers, a printer, etc. are also included according to an aspect. The aforementioned devices are examples and others may be used. According to an aspect, the computing device 1300 includes one or more communication connections 1316 allowing communications with other computing devices 1318. Examples of suitable communication connections 1316 include, but are not limited to, radio frequency (RF) transmitter, receiver, and/or transceiver circuitry; universal serial bus (USB), parallel, and/or serial ports.

The term computer readable media, as used herein, includes computer storage media apparatuses and articles of manufacture. Computer storage media include volatile and nonvolatile, removable and non-removable media implemented in any method or technology for storage of information, such as computer readable instructions, data structures, or program modules. The system memory 1304, the removable storage device 1309, and the non-removable storage device 1310 are all computer storage media examples (i.e., memory storage). According to an aspect, computer storage media include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1300. According to an aspect, any such computer storage media is part of the computing device 1300. Computer storage media do not include a carrier wave or other propagated data signal.

According to an aspect, communication media are embodied by computer readable instructions, data structures, program modules, or other data in a modulated data signal, such as a carrier wave or other transport mechanism, and include any information delivery media. According to an aspect, the term “modulated data signal” describes a signal that has one or more characteristics set or changed in such a manner as to encode information in the signal. By way of example, and not limitation, communication media include wired media such as a wired network or direct-wired connection, and wireless media such as acoustic, radio frequency (RF), infrared, and other wireless media.

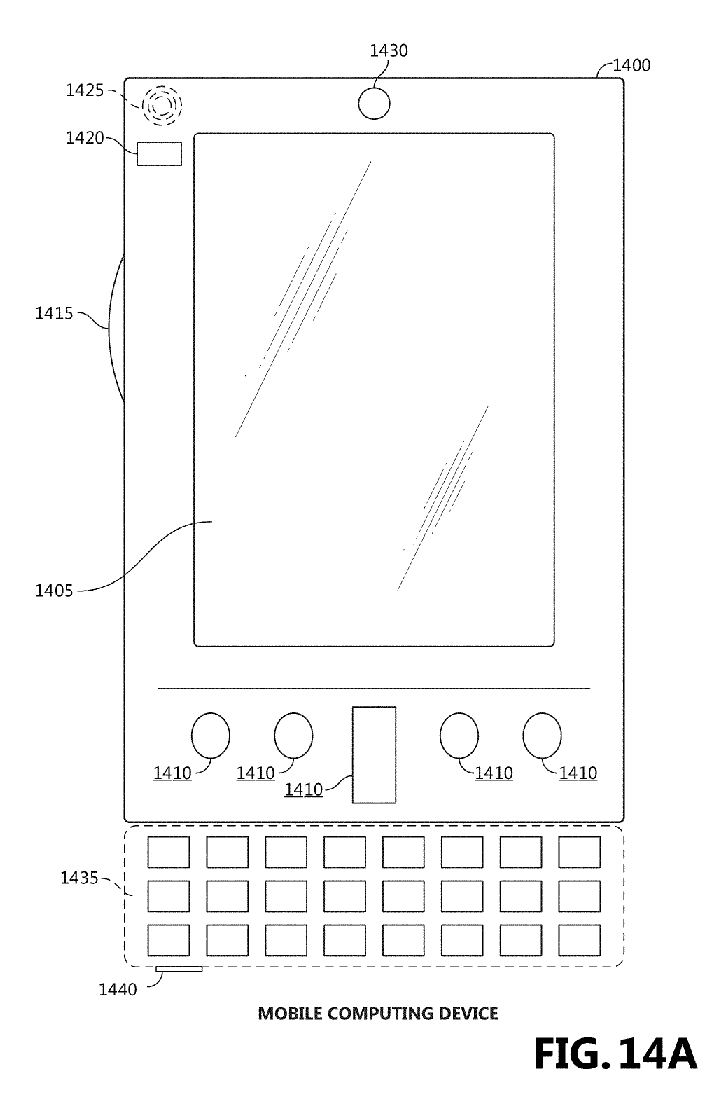

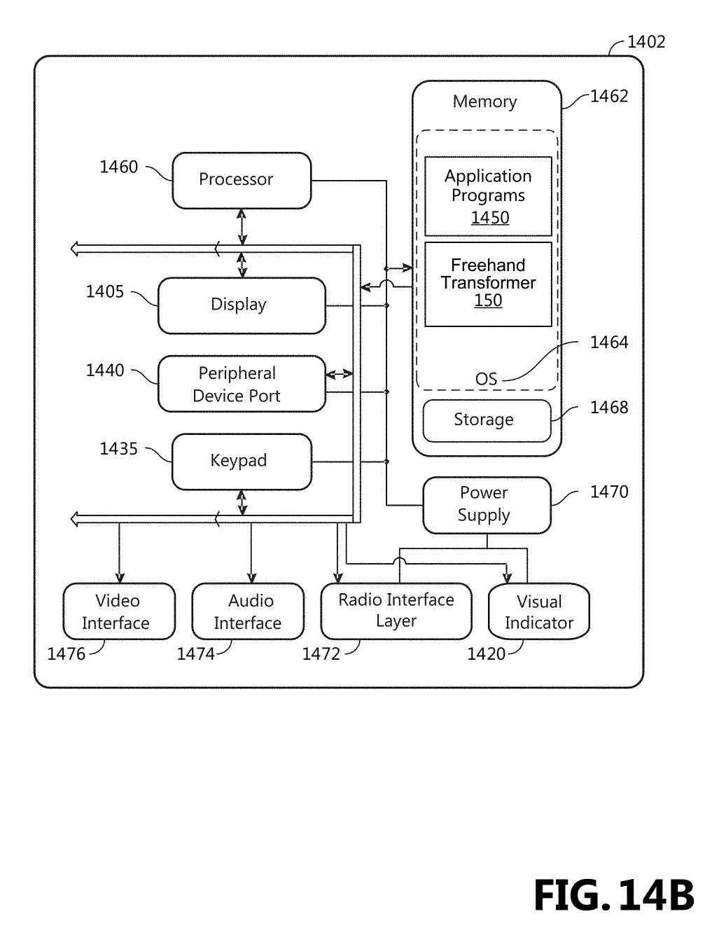

FIGS. 14A and 14B illustrate a mobile computing device 1400, for example, a mobile telephone, a smart phone, a tablet personal computer, a laptop computer, and the like, with which aspects may be practiced. With reference to FIG. 14A, an example of a mobile computing device 1400 for implementing the aspects is illustrated. In a basic configuration, the mobile computing device 1400 is a handheld computer having both input elements and output elements. The mobile computing device 1400 typically includes a display 1405 and one or more input buttons 1410 that allow the user to enter information into the mobile computing device 1400. According to an aspect, the display 1405 of the mobile computing device 1400 functions as an input device (e.g., a touch screen display). If included, an optional side input element 1415 allows further user input. According to an aspect, the side input element 1415 is a rotary switch, a button, or any other type of manual input element. In alternative examples, mobile computing device 1400 incorporates more or fewer input elements. For example, the display 1405 may not be a touch screen in some examples. In alternative examples, the mobile computing device 1400 is a portable phone system, such as a cellular phone. According to an aspect, the mobile computing device 1400 includes an optional keypad 1435. According to an aspect, the optional keypad 1435 is a physical keypad. According to another aspect, the optional keypad 1435 is a “soft” keypad generated on the touch screen display. In various aspects, the output elements include the display 1405 for showing a graphical user interface (GUI), a visual indicator 1420 (e.g., a light emitting diode), and/or an audio transducer 1425 (e.g., a speaker). In some examples, the mobile computing device 1400 incorporates a vibration transducer for providing the user with tactile feedback. In yet another example, the mobile computing device 1400 incorporates a peripheral device port 1440, such as an audio input (e.g., a microphone jack), an audio output (e.g., a headphone jack), and a video output (e.g., a HDMI port) for sending signals to or receiving signals from an external device.

FIG. 14B is a block diagram illustrating the architecture of one example of a mobile computing device. That is, the mobile computing device 1400 incorporates a system (i.e., an architecture) 1402 to implement some examples. In one example, the system 1402 is implemented as a “smart phone” capable of running one or more applications (e.g., browser, e-mail, calendaring, contact managers, messaging clients, games, and media clients/players). In some examples, the system 1402 is integrated as a computing device, such as an integrated personal digital assistant (PDA) and wireless phone.

According to an aspect, one or more application programs 1450 are loaded into the memory 1462 and run on or in association with the operating system 1464. Examples of the application programs include phone dialer programs, e-mail programs, personal information management (PIM) programs, word processing programs, spreadsheet programs, Internet browser programs, messaging programs, and so forth. According to an aspect, a freehand transformer 150 is loaded into memory 1462. The system 1402 also includes a non-volatile storage area 1468 within the memory 1462. The non-volatile storage area 1468 is used to store persistent information that should not be lost if the system 1402 is powered down. The application programs 1450 may use and store information in the non-volatile storage area 1468, such as e-mail or other messages used by an e-mail application, and the like. A synchronization application (not shown) also resides on the system 1402 and is programmed to interact with a corresponding synchronization application resident on a host computer to keep the information stored in the non-volatile storage area 1468 synchronized with corresponding information stored at the host computer. As should be appreciated, other applications may be loaded into the memory 1462 and run on the mobile computing device 1400.

According to an aspect, the system 1402 has a power supply 1470, which is implemented as one or more batteries. According to an aspect, the power supply 1470 further includes an external power source, such as an AC adapter or a powered docking cradle that supplements or recharges the batteries.

According to an aspect, the system 1402 includes a radio 1472 that performs the function of transmitting and receiving radio frequency communications. The radio 1472 facilitates wireless connectivity between the system 1402 and the “outside world,” via a communications carrier or service provider. Transmissions to and from the radio 1472 are conducted under control of the operating system 1464. In other words, communications received by the radio 1472 may be disseminated to the application programs 1450 via the operating system 1464, and vice versa.

According to an aspect, the visual indicator 1420 is used to provide visual notifications and/or an audio interface 1474 is used for producing audible notifications via the audio transducer 1425. In the illustrated example, the visual indicator 1420 is a light emitting diode (LED) and the audio transducer 1425 is a speaker. These devices may be directly coupled to the power supply 1470 so that when activated, they remain on for a duration dictated by the notification mechanism even though the processor 1460 and other components might shut down for conserving battery power. The LED may be programmed to remain on indefinitely until the user takes action to indicate the powered-on status of the device. The audio interface 1474 is used to provide audible signals to and receive audible signals from the user. For example, in addition to being coupled to the audio transducer 1425, the audio interface 1474 may also be coupled to a microphone to receive audible input, such as to facilitate a telephone conversation. According to an aspect, the system 1402 further includes a video interface 1476 that enables an operation of an on-board camera 1430 to record still images, video stream, and the like.

According to an aspect, a mobile computing device 1400 implementing the system 1402 has additional features or functionality. For example, the mobile computing device 1400 includes additional data storage devices (removable and/or non-removable) such as, magnetic disks, optical disks, or tape. Such additional storage is illustrated in FIG. 14B by the non-volatile storage area 1468.

According to an aspect, data/information generated or captured by the mobile computing device 1400 and stored via the system 1402 are stored locally on the mobile computing device 1400, as described above. According to another aspect, the data are stored on any number of storage media that are accessible by the device via the radio 1472 or via a wired connection between the mobile computing device 1400 and a separate computing device associated with the mobile computing device 1400, for example, a server computer in a distributed computing network, such as the Internet. As should be appreciated, such data/information are accessible via the mobile computing device 1400 via the radio 1472 or via a distributed computing network. Similarly, according to an aspect, such data/information are readily transferred between computing devices for storage and use according to well-known data/information transfer and storage means, including electronic mail and collaborative data/information sharing systems.

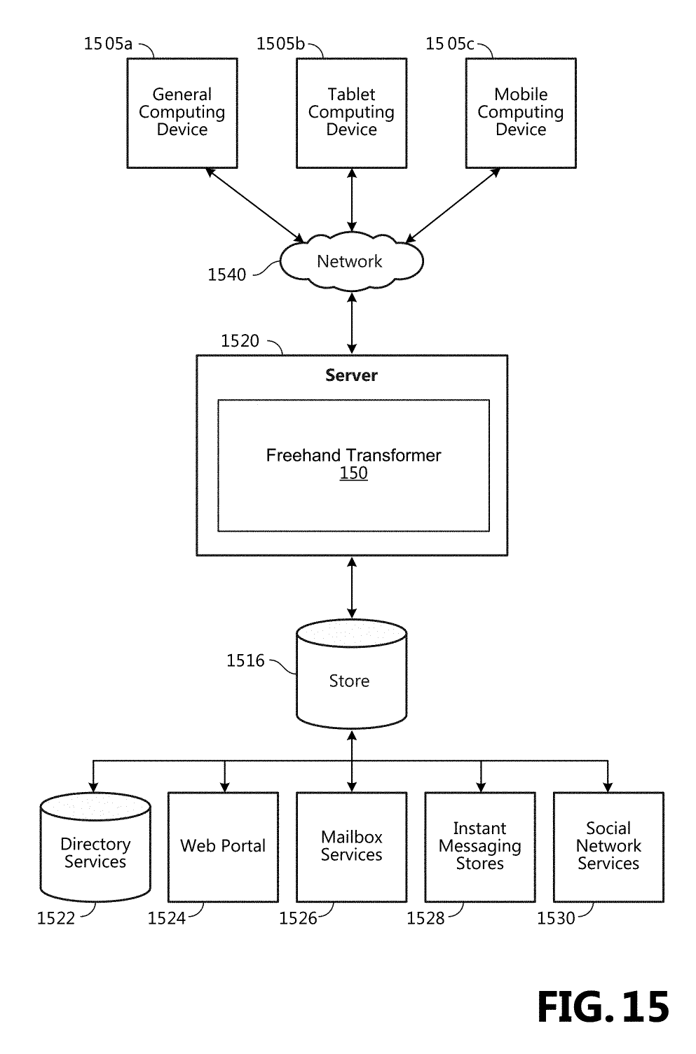

FIG. 15 illustrates one example of the architecture of a system for intelligent detection and manipulation of objects via freehand input as described above. Content developed, interacted with, or edited in association with the freehand transformer 150 is enabled to be stored in different communication channels or other storage types. For example, various documents may be stored using a directory service 1522, a web portal 1524, a mailbox service 1526, an instant messaging store 1528, or a social networking site 1530. The freehand transformer 150 is operative to use any of these types of systems or the like for intelligent detection and manipulation of objects via freehand input, as described herein. According to an aspect, a server 1520 provides the freehand transformer 150 to clients 1505a-c (generally clients 1505). The server 1520 provides the freehand transformer 150 over the web to clients 1505 through a network 1540. By way of example, the client computing device is implemented and embodied in a personal computer 1505a, a tablet computing device 1505b or a mobile computing device 1505c (e.g., a smart phone), or other computing device. Any of these examples of the client computing device are operable to obtain content from the store 1516.

Implementations, for example, are described above with reference to block diagrams and/or operational illustrations of methods, systems, and computer program products according to aspects. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more examples provided in this application are not intended to limit or restrict the scope as claimed in any way. The aspects, examples, and details provided in this application are considered sufficient to convey possession and enable others to make and use the best mode. Implementations should not be construed as being limited to any aspect, example, or detail provided in this application. Regardless of whether shown and described in combination or separately, the various features (both structural and methodological) are intended to be selectively included or omitted to produce an example with a particular set of features. Having been provided with the description and illustration of the present application, one skilled in the art may envision variations, modifications, and alternate examples falling within the spirit of the broader aspects of the general inventive concept embodied in this application that do not depart from the broader scope of the present disclosure.

We claim:

1. A method for intelligent detection of a table from freehand input, comprising:
displaying an application including a user interface configured to receive freehand input;
receiving freehand input from a user, wherein the freehand input includes one or more strokes;
determining whether the freehand input defines a freehand table;
in response to determining the freehand input defines the freehand table, generating an enriched table that provides functionality for a user to interact with the enriched table;
modifying the application to include the enriched table; and
displaying the enriched table.

2. The method of claim 1, wherein the freehand input is received coincident with an existing object in the user interface, the existing object defining a border of the freehand table.

3. The method of claim 1, wherein determining whether the freehand input defines the freehand table includes determining whether strokes comprising freehand input are substantially parallel.

4. The method of claim 1, wherein determining whether the freehand input defines the freehand table includes comparing the freehand input satisfies a size threshold for a freehand table.

5. The method of claim 1, wherein an outer border of the freehand table inherits look-and-feel properties from the freehand input used to define the outer border.

6. The method of claim 1, further comprising:
receiving a second freehand input that includes one or more strokes that interact with the freehand table.

7. The method of claim 6, further comprising:
identifying a modification to the freehand table based the one or more strokes of the second freehand input.

8. The method of claim 7, further comprising:
updating the freehand table to reflect the modification; and
displaying the modified freehand table

9. The method of claim 7, wherein the modification to the freehand table inserts a value into a cell of the freehand table.

10. A method for intelligent manipulation of an enriched table via freehand input, comprising:
displaying a preexisting enriched table within an application;
receiving a user interaction with the preexisting enriched table;
receiving freehand input that includes one or more strokes that interact with the preexisting enriched table;
identifying a modification to the preexisting enriched table based the one or more strokes of the freehand input;
updating the preexisting enriched table to reflect the modification; and
displaying the modified enriched table.

11. The method of claim 10, wherein the modification to the preexisting enriched table inserts a value into a cell of the preexisting enriched table.

12. The method of claim 10, wherein the modification to the preexisting enriched table applies a look-and-feel property from the freehand input to the preexisting enriched table.

13. The method of claim 10, wherein the modification to the preexisting enriched table changes a number of cells comprising the preexisting enriched table.

14. The method of claim 10, wherein the modification to the preexisting enriched table reorganizes the cells comprising the preexisting enriched table.

15. A method for intelligent manipulation of a table contents via freehand input, comprising:
displaying an application including a canvas area to receive freehand input, the canvas area including an enriched table comprising one or more cells;
receiving, in the canvas area, the freehand input including one or more strokes indicating a user interaction with the enriched table, the freehand input received coincident with a cell of the one or more cells;
identifying a candidate value based on the one or more strokes;
updating a value of the cell to include the candidate value; and
removing the one or more strokes of the freehand input from the application.

16. The method of claim 15, further comprising:
receiving a second freehand input to sort values in the one or more cells within a given row or column of the enriched table; and
sorting the values in the one or more cells within the given row or column.

17. The method of claim 15, wherein the candidate value is incorporated into a formula of the cell.

18. The method of claim 15, further comprising:
displaying the one or more strokes in the cell; and
displaying computer-generated characters for the candidate value in the cell.

19. The method of claim 18, further comprising:
providing a control associated with the computer-generated characters selectable via freehand input; and
in response to receiving a selection of the control, identifying a second candidate value and updating the value of the cell from the candidate value to the second candidate value.

20. The method of claim 15, wherein multiple alphanumeric characters are identified from the one or more strokes as comprising the candidate value.
